(19) United States
(12) Patent Application Publication
(10) Pub. No.: US 2017/0187722 A1
(43) Pub. Date: Jun. 29, 2017

(54) SENSOR BASED PRIVACY CENTRIC NETWORK COMMUNICATION, SHARING, RANKING TOOLS AND OTHER TOOLS

(71) Applicant: AutoGraph, Inc., Seattle, WA (US)

(72) Inventor: Brian Roundtree, Seattle, WA (US)

(21) Appl. No.: 15/389,226

(22) Filed: Dec. 22, 2016

Related U.S. Application Data
(60) Provisional application No. 62/387,277, filed on Dec. 23, 2015.

(51) Int. Cl. H04L 29/06; H04W 8/18; G06Q 30/00; H04W 4/02; H04W 8/00; H04W 4/06; H04L 29/08

(52) U.S. Cl. CPC H04L 63/107; H04W 4/06; H04W 8/18; H04L 67/306; H04W 4/021; H04W 8/005; H04L 63/0407; G06Q 30/0185

(57) ABSTRACT

This disclosed tools include embodiments of beacon proximity verification tools, tools to leverage custom beacon signals via end user device awareness and personalization as well as tools for enhanced consumer device notifications.

### RELATED APPLICATION(S)

This application claims the benefit of and priority to the following U.S. Provisional Patent Application No. 62/387,277 filed Dec. 23, 2015, which is incorporated herein by reference in its entirety.

The following previously filed applications are herein incorporated by reference:

U.S. Provisional Patent Application No. 61/972,193.

BEACON BASED PRIVACY CENTRIC NETWORK COMMUNICATION, SHARING, RELEVANCY TOOLS AND OTHER TOOLS, U.S. patent application Ser. No. 14/672,007 filed Mar. 27, 2015.

BEACON BASED PRIVACY CENTRIC NETWORK COMMUNICATION, SHARING, RELEVANCY TOOLS AND OTHER TOOLS PCT Patent Application No. PCT/US2015/23191 filed Mar. 27, 2015.

The technology in these applications as well as the current application are interoperable.

### APPENDICES

Appendix A has a brief description of technologies described in the incorporated applications.

### BACKGROUND

First, human error and fraud have always been significant issues for businesses conducting business on the Internet. With the advent of beacon technology, new opportunities for human error and fraud are possible. What is needed are tools to mitigate such threats without adding expensive complexity to businesses in terms of expense and computational effort for lower security transactions e.g., solutions that do not warrant extreme security methods for lower risk transactions such as verifying identity for supermarket loyalty programs etc. Specifically, what is needed is an inexpensive and effective tool to verify that a device such as an end user device as well as beacons are in the right locations.

On such example of human error involving beacons is if a beacon is mistakenly physically placed at an incorrect location. One such example may be if an iBeacon was mistakenly placed by an employee at a Tully's coffee shop transmitting an identity registered not to Tully's but to another business such as Starbucks. End users, such as a consumer within range of the Tully's, would be erroneously detecting a beacon associated to Starbucks.

An example of nefarious activity using beacons is if a criminal wanted to illegally receive supermarket rewards points without being on the premises. Said points being granted on the condition that the user's device actually enters the supermarket's geophysical location. A criminal may circumvent this physical presence requirement and try can get the reward points without being in physical range at all. Instead, he remotely determines the beacon signals that would be broadcast from each physical location and remotely simulates his presence in the geophysical location to get the reward points to “game” the system.

Thus what is needed is a simple, cost effective tool(s) to verify the actual physical presence of both beacons and end user devices in a given physical area/range of each other. In addition, the above tools would be especially helpful for lower level security procedures such as well as verifying beacon proximity and interest before additional and higher security procedures like logging on to a customer account are initiated.

Second, previously, technology has focused on devices such as central/community computing devices such as IPTVs, smart refrigerators, computers etc., attempting to determine which users are in proximity. These devices have been the type that are useable by a plurality of users simultaneously such as a large screen TV which is able to be viewed by many users at the same time. As such, these central devices and not the user's devices have made group decisions (e.g., suggestions on TV programs to watch that everyone in the room would all prefer etc.).

However, as non-central/community devices e.g., personal devices such as smart phones/tablets have recently become widespread and much more powerful, what is needed are tools which focus not on “central/community” devices such as IPTVs solely determining the mere user presence of user devices (e.g., phones, RFID chips and tablets).

Rather, proximal users and devices directly interfacing with central devices as well as both central and personal devices sharing their properties and information to proximal devices is needed. This increases the context of the surrounding environment, which allows better decision making to occur e.g., exactly who and what devise are in a living room and what they want to watch on a TV with a certain size screen. Thus, tools are needed that focus on enabling personal devices to themselves gather information about not only relevant central devices but other relevant personal devices in proximity and information about users profiles associated to said proximal personal devices. Also needed is better control over user privacy.

Finally, a long-standing problem merchants face is determining what specifically about a particular good/service is of interest to a consumer. Interest varies substantially depending on the individual consumer. Specifically, out of a plurality of characteristics, what specific characteristic(s) about the good/service is a specific consumer focused on as opposed to what different characteristic a second consumer may focus on.

For instance, if a product was a pink iPhone case with a sparkly diamond pattern, different consumers may react differently to these properties. A first consumer may only react positively to the pink characteristic while another my only react to the diamond pattern or may even react negatively or neutrally to the pattern. Thus, what is needed is substantial granularity in determining what properties of a good/service/ad/coupon/tv show/content etc., trigger a positive/negative or neutral reaction specific to a particular consumer and her profile.

### BRIEF DESCRIPTION OF THE DRAWINGS

FIG. 1 illustrates an embodiment of proximity verification using the disclosed technology;

FIG. 2 illustrates exemplary steps of proximity verification using the disclosed technology;

FIG. 3 illustrates additional exemplary steps of proximity verification using the disclosed technology;

FIG. 4 illustrates exemplary steps for data signal customization tools using the disclosed technology;

FIG. 5 illustrates exemplary end user device awareness and personalization tools using the disclosed technology;

FIG. 6 illustrates a single user embodiment of iBeacon signal customization tools using the disclosed technology;

FIG. 7 illustrates a multiple user embodiment of iBeacon signal customization tools using the disclosed technology; and

FIG. 8 illustrates an embodiment of enhanced consumer device notification tools using the disclosed technology.

### DETAILED DESCRIPTION

Tools that are described herein include:
Toolset #1: Beacon Proximity Verification Tools;
Toolset #2: Leveraging iBeacon Signal Data Customization Tools Via End User Device Awareness And Personalization Tools; and
Toolset #3 Enhanced Consumer Device Notification System

### Toolset #1: Beacon Proximity Verification Tools

### Overview-Proximity and Interest Verification of an End User

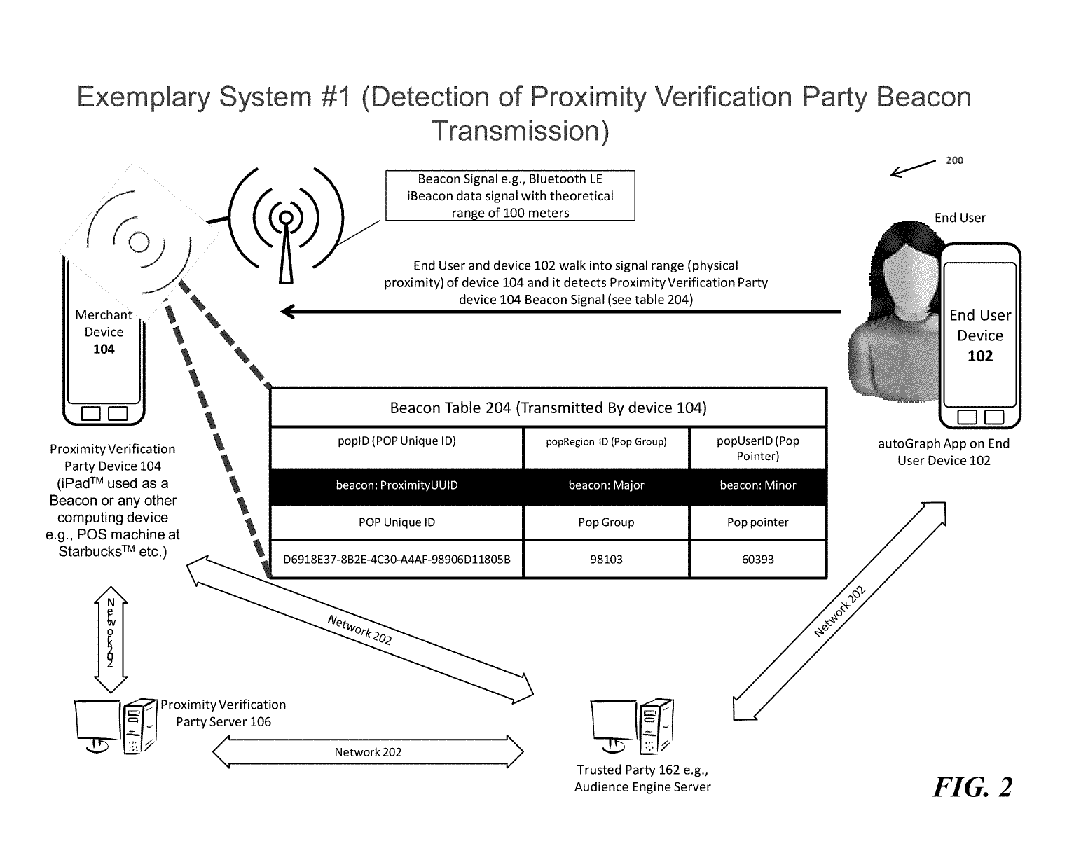

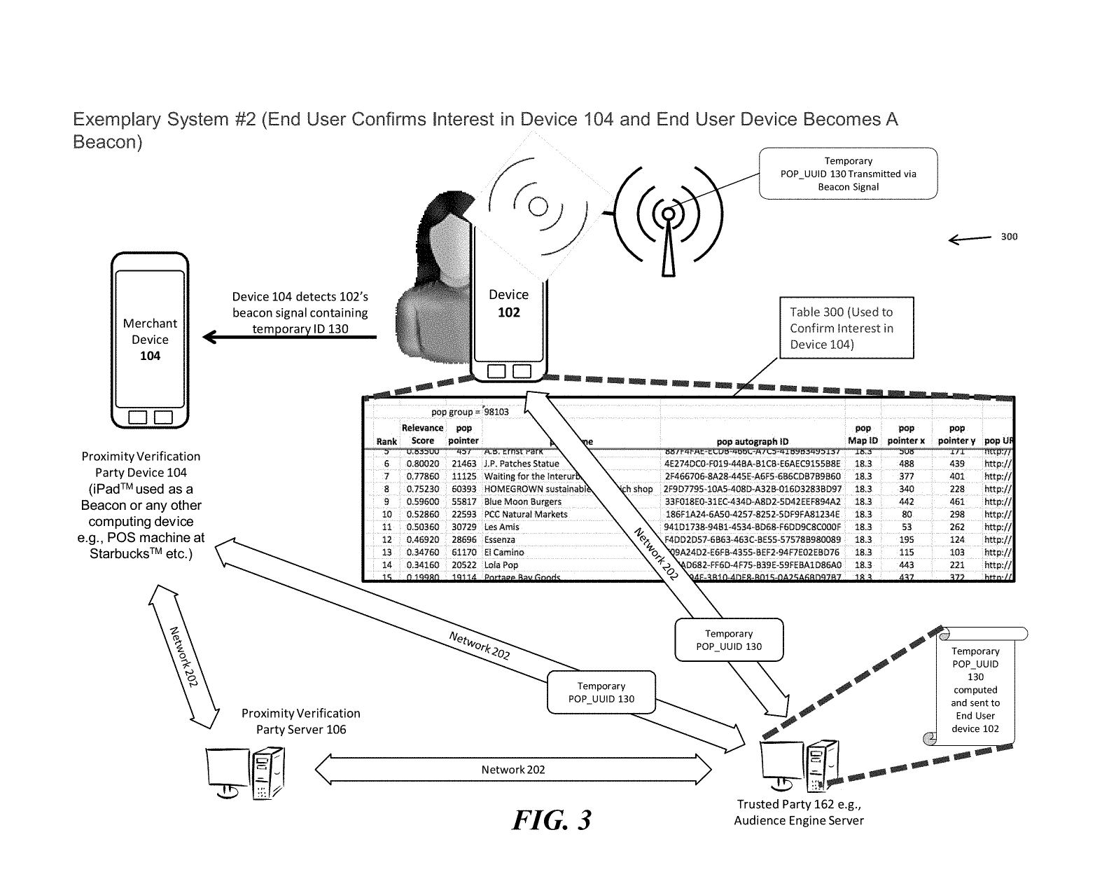

System 200 in FIGS. 2 and 3 illustrate one embodiment of various computing device location/proximity verification and user interest tools. Specifically, this embodiment focuses on providing substantial end user location/proximity verification for an end user (consumer/shopper) device 102 as well as optional end user interest verification in goods/services associated to beacons in proximity to said end user device (discussed at length in the above referenced patent applications). In this particular embodiment, proximity verification between end user device 102 and device 104 is optionally conducted before typical identity verification (e.g., logging on to a merchant server) is conducted. Thus proximity verification serves to supplement the typical identity verification steps (e.g., logging on to a website) to deter fraud. This is because proximity verification aid in stopping criminals who are not actually within proximity of device 104 (e.g., the supermarket premises) from nefariously remotely logging into the merchant's computing devices.

In FIG. 2, proximity verification deters fraud by requiring that the end user's device 102 detect and then later transmit directly (e.g., in a non-networked communication manner) to a proximal merchant device 104. Said detection and transmission is aimed at limiting these steps for an end user device 102 that is actually within a certain geophysical single range/proximity of the devices 102 and 104. This relatively quick and computational resource friendly proximity verification toolset is especially useful for lower risk transactions such as supermarket loyalty transactions. Such verifications do not usually economically merit overly complex security measures, which would unduly burden the expense of technology deployment, consumer comprehension, involvement, computational/battery/bandwidth expense and compliance with exotic security procedures and computational overhead for all involved parties.

Overview of the Proximity Verification Process: A proximity verification request is sent by device 102 to device 104, and is passed on by device 104 to a trusted party audience engine server 162. In turn, the trusted party sever 162 calculates a temporary code, temporary ID, such as a temporary POP_UUID 130 or other data (which may be temporary or permanent) and transmits it to directly to end user device 102 and optionally to device 104. In turn, device 102 will broadcast the POP_UUID to device 104. In order for this last step to occur, device 102 must be in signal range (proximity) to device 104, thus verifying proximity by a comparison of temporary POP_UUID/temporary ID 130s that are transmitted and received by the devices above with, for example, a substantially small time period e.g., 10 seconds etc. “POP” and other beacon terminology was defined in the above referenced applications and is provided below for convenience:

POP=Proximity Of Preferences device (e.g., a beacon)
a. A POP may be a Beacon and/or device that detects beacons that may be associated with a profile (Advertar, interest graph, social graph etc.) like construct associated with it. The construct may be substantially similar to a profile of a user, offer/ad or both. The profile may include their characteristics, demographics and other properties and associated statistical probabilities/probability distribution (e.g., propensity) of a characteristic being representative of a user/beacon or certain population of users (as determined by consumer surveys/marketing data demographics and other properties, assigned categories, price points, associated geographical locations, ownership or association information (e.g., what merchant store they are placed at and/or what product they are associated to) or any other desired data. Such an example of a characteristic and an associated statistical probability may be: a 51% chance that the user is a female. Any units or scale may be used to indicate a statistical probability. Beacons may also be associated to profiles. These have been discussed in the above referenced applications.

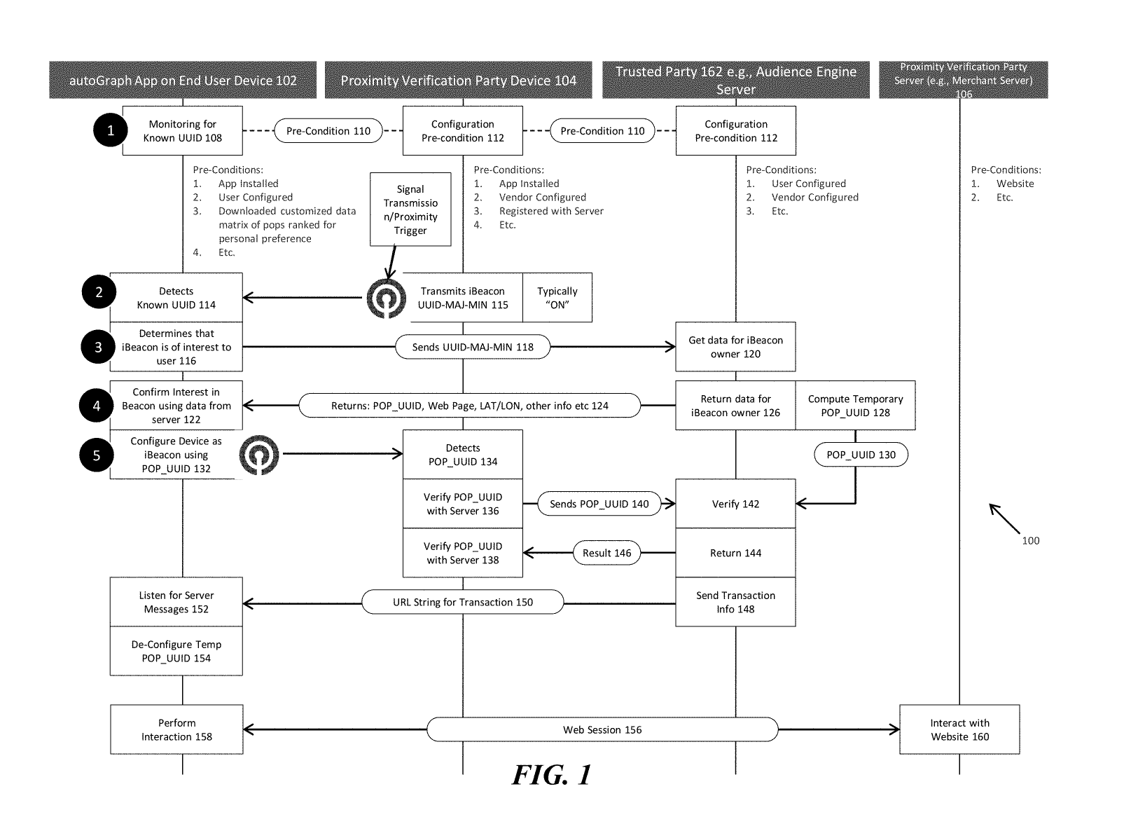

FIG. 2 illustrates the first part of proximity verification starting with a signal transmission by a merchant device configured as a device 104 (e.g., iBeacon). First in FIG. 2, an end user and her preconfigured device 102 (smartphone, slate computer, tablet, laptop, smart watch, PDA or the like) enters physical detection range/proximity of device 104's signal. The devices in FIGS. 1-3 may transmit/receive signals according to protocols such as the Apple™ iBeacon specification, Bluetooth Low Energy specification or other specifications.

Device 104 may be a point of sale device, iPhone, iPad or other computing device that can transmit a beacon signal such as a Bluetooth, cellular, Wi-Fi or other signal that is detectable by device 102. As discussed in the above referenced patent applications, information such as that contained in table 204 (see FIG. 2) maybe transmitted by device 104 via a Bluetooth signal. In FIG. 2, information in table 204 will be used by device 102 and other devices to verify proximity to device 104, identify device 104, associate related goods/services/location/data with device 104, determine the end user's interest/rank the aforementioned in light of a profile associated to the end user and for other purposes.

Addressing, exemplary pre-configuration of the devices for the steps in FIG. 1 to occur: device 102 is programmed or is configured to detect device 104's signal with preconfigured instructions. Not only does pre-configuration of device 102 allow recognition of device 104's signal as being associated to certain goods/services, pre-configuration allows device 102 to transmit a request to start the proximity verification process as well as optionally, a user interest verification process.

Moving on in the proximity verification process: as illustrated in FIG. 3, which illustrates the second part of proximity verification (End User Device Beacon Transmission), device 102 then broadcasts or otherwise transmits (e.g., via a non-networked manner) a received temporary ID or code such as POP_UUID (e.g., given to device 102 from device 162 e.g., the trusted party server) to device 104 once the user interest verification is done (e.g., via Bluetooth signal). Receipt of the ID or code by device 104 verifies that the device 102 is in proximity of device 104 as discussed below.

In one embodiment, when device 104 receives the temporary ID (e.g., a temporary POP_UUID or other code) from device 102, device 104 may then request a temporary ID from device 162. Then device 104 may then locally match the received temporary ID from device 102 to that of the temporary ID received from device 162. If the two received IDs match, then it substantially verifies the proximity of the user because device 102 had to have been within signal range (proximity) of device 104 during at least a substantially small portion of time between the above steps.

Alternately, device 104 may pass on the received temporary ID from device 102 to device 162 for comparison/matching. If the two IDs match, then device 104 will receive confirmation from device 162 that the received temporary ID was issued to device 102. In a like manner, verification may be contingent in the above steps occurring within a substantially small time.

Once proximity verification is determined, then transactions may proceed between device 102 and device 104 with substantial assurance of the proximity of the end user. In addition, various actions can then be triggered such as waking a specific preconfigured application on the device 102, executing commands on any of the above devices, receiving customer loyalty reward points (e.g., awarded by proximity verification party server 106—the grocery store's server) or other actions discussed in the above referenced patent applications such as those discussed in reference to the table 300 (see FIG. 3) of ranked beacons as discussed in relation to this same table in the above referenced patent applications.

Table 300 can also be optionally used with the verification process as discussed below. For example, before, during or after the above steps, a determination is optionally made to determine if device 102's end user is likely interested in goods/services, which are associated with device 104's signal. For example, in one embodiment, device 102 additionally determines if the end user's profile reflects a likely interest in the goods/services associated to device 104 e.g., if device 104 is a POS machine at Starbucks™ and if the end user is interested in coffee, then proximity verification steps may proceed. If the user is not, then the verification process may terminate or the user may be asked if the process should occur and/or if she is interested in the goods/services related to the beacon.

If proximity verification includes asking the user to verify interest in a detected beacon, verification of end user device 102's proximity to merchant device 104 may occur before or after the end user device or a specific application on the device notifies the end user that the detected a beacon/device 104 may be of interest. Proximity verification can also happen before, after or during a transaction with a trusted server/proximity verification party server (or the proximity verification party server 106) or at other times when a merchant's device(s) or other device that needs to verify the proximity of the end user to another device such as device 104.

### Embodiments

FIG. 1's system 100 illustrates an embodiment of an end user verifying her interest in the goods and services offered by the merchant associated with device 104 and then her proximity to device 104. More specifically, once the proximity and interests are confirmed, verification credentials may be issued to device 102 to conduct website interactions or for other purposes that require quick and less costly end user proximity verification to prevent fraud.

### Preconfiguration of Devices for Proximity Verification

FIG. 1, step 1 comprises pre-configuration of end user device 102, proximity verification party device 104 (e.g., merchant POS device), trusted party server audience engine 162 and optionally a proximity verification party server 106 (e.g., merchant server). Pre-configuration such as by executing a program (e.g., an iphone application) or operating configured logic circuitry permits certain communication, recognition and other interactions between these devices via direct non-networked signals (to help verify proximity) such as Bluetooth signal but also allows some communication over a network such as network 202 for those communication steps that are not necessarily needed to verify proximity. In one embodiment, only direct non-networked signals are permitted between devices 102 and 104 when transmitting a temporary ID to each other.

As illustrated in FIG. 1, various preconditions 112/pre-conditions 110 like having software applications installed, user/merchant configuration of desired settings, downloading end user beacon matrixes (table 300) generated from available beacons and the end user profile/interest graph, device registration with servers, having an available merchant website for the end user to interact with may be done to help enable the steps in FIG. 1. These are discussed in the above referenced patent applications.

In one embodiment, device 102 maybe any computing device such as mobile computing device such as a smartphone, phablet, tablet, laptop, Apple Watch™, wearable computing device or other computing device. Device 102 may include a transceiver to receive signals from device 104 or other devices and hardware to connect to a network such as the Internet via wireless or wired connections.

In one embodiment, device 102 is configured similar to devices discussed in the above referenced patent applications. For instance, in order for device 102 to recognize signals, devices and appropriate commands illustrated in FIG. 1, device 102 and/or 104 may download an app from iTunes™ or Google Play™. The app may configure device 102 to monitor for specific Bluetooth or other wireless signals (e.g., at 108 in FIG. 1) such as those emitted by certain beacons such as device 104. These wireless signals from 104 are detected and recognized by device 102 when the device enters geophysical proximity (within signal range) of the transmitting beacon signal. The device 104 may transmit information like that in table 204 or transmit other data that identify the beacon to device 102 via the iBeacon protocol or other tools. Table 204 may be used during end user proximity verification. Device 102 may also be preconfigured to communicate with trusted party server 162 as well as other devices such as proximity verification party server 106.

### Embodiment of End User Verification of her Proximity and Interests Before End User Logs onto a Merchant Server

As introduced above, proximity verification uses the limited and substantially predictable signal range of a signal (e.g., a non-networked connection) emitted by devices 102 and 104 (e.g., at 132 and 116). Specifically, the non-networked signal is limited by physical range of the signal, which verifies the proximity of device 102 to that of within the signal's range. For instance, if device 104's signal was Bluetooth, then the signal range would typically be a 33 foot to 70-100 meter radius around device 104. As implied above, certain devices with network communication access are configured to send/receive certain data (e.g., a temporary ID) only via direct non-networked communication at certain steps in FIG. 1 to ensure actual proximity verification of end user device 102 to that of device 104.

FIG. 1, step 2, illustrates steps beginning with devices such as device 102 entering within a certain physical range/proximity such as device 104's signal range. In this embodiment, steps 108 to 144 serve as proximity and interest verification steps. These verifications may serve as a prerequisite before the user of device 102 can log on or otherwise interact with the merchant's server (e.g., proximity verification party server 106). This not only provides an extra layer of security, but also ensures that a user will not be needlessly notified by device 102 by detected beacons she is not actually interested in or in proximity to a relevant geophysical location.

As illustrated at 114, device 102 is within signal range of device 104 and with the preconfiguration of the various devices 102 and 104 discussed above, allows device 102 to detect and recognize the beacon signal data emitted by device 104. More specifically at 114, device 102 detects a preregistered UUID (e.g., during the below discussed preconfiguration steps) that was transmitted by device 104 at 115. Device 104 typically continuously transmits the beacon signal to enable end users who walk substantially near it to detect the signal at all times or alternately only during times the owner of device 104 wishes. The signal emitted by device 104 at 115 may act as a proximity trigger to start the steps below.

At step 3, an optional interest determination (which was discussed in the above referenced patent applications) is made to determine if the end user of device 102 is likely interested in the goods/services/location/data associated to device 104 and/or device 106 or other devices. This may occur locally on device 102 or on device 104 or on a remote server such as a trusted party device or other device at 116. For example, as the user detects beacons like beacon 104's UUID, major and minimum, this detected beacon data is matched with data stored on device 102. Specifically, this detected beacon data may be matched with ranked data similar to FIG. 3's beacon table 300 to determine user interest in the detected device 104 or its associated goods/services. This is discussed further in the above referenced patent applications.

In one embodiment, beacon table 300 may store preregistered beacons (such as device 104) associated with a certain relative user interest score calculated by considering the profile/interest graph for the user of device 102. Specifically, relevance scores can be calculated by considering end user's profile/interest graph in relation to tags associated to the beacon (e.g., associated on the audience engine server 162) as tagged beforehand by the merchant or other person. This scoring and ranking may occur before or during the steps illustrated in FIG. 1. FIG. 3's table 300 can be downloaded onto device 102 before or after device 102 detects beacons in a desired area e.g., once the user enters an area such as a ZIP code, the beacons of that ZIP code are downloaded or otherwise considered by an audience engine and relevant beacon UUID, Maj/Min sent to device 102. If optional step 116 determines that a desired threshold interest score is met for the beacon, we further proceed in FIG. 1.

At 118, device 102 may optionally transmit the detected information received from device 104 information (UUID, major, minimum) to other devices to further assist in identification/recognition/interest verification of device 104 if the data from preconfiguration on device 102 is insufficient e.g., get more information 120 about device 104 to display it to the user of device 102. This request 118 for additional beacon data may be sent by device 102 to device 104, 162 or 106. Information that maybe returned to device 102 may be goods/services/data associated to the beacon such as hours the merchant is open, current sales, Yelp reviews, weather, ads, brands, content etc.

Alternately this request 118 by device 102 for more information may be made if it is decided the user is likely interested and more information is needed to display further information to the user for confirmation of interest, display of content/ads etc. More specifically, data about the iBeacon owner 124 (e.g., device 104) can be optionally retrieved 126, an application or device operating system on the device (such as device 102) “awoken” and information displayed to the end user at 122 for user interest confirmation or other purposes. For instance, if the signal from device 104 is from a Starbucks' iBeacon at its Seattle store, the signal may include data pertaining to that particular store's goods and services and other data such as current coupons, ads, brands, POP-UUID, current offer of customer loyalty points, webpages, latitude/longitude etc.

In one embodiment, step 4 at 122, the user of device 102 may be optionally asked to verify that she is actually interested in the goods/services/location/data associated to beacon 104. In one example, the beacon may be offering loyalty points or other goods/servers in return for physically entering the merchant's location. Specifically, device 102 may also ask the user of device 102 to confirm or deny interest in device 104 or the associated data above such as the downloaded content, tags etc., e.g., “are you interested in receiving customer loyalty points today for merchant XYZ?”. Sounds, vibrations and/or display alerts can be executed to alter the consumer to ask and confirm interest. Confirmation maybe input by Swote input e.g., Swote input up or down on pieces of content related to the beacon's goods/services/location/data or other tools, a touch screen, voice, motion, camera, accelerometer or other user input may also be used. If the user of device 102 input a positive interest using these optional steps, then processing optionally proceeds further in the figure. In one embodiment, steps 116, 118, 120, and 122 are optional and can be executed in any combination desired. For instance, device 102 could simply just request a temporary ID such as a temporary POP_UUID 130 be generated as discussed below and the device 102 would start transmitting like in step 132 below.

At steps 4-5 of the proximity verification process, at 128, device 162 or other device may compute a temporary ID such as a temporary POP-UUID 130. This serves as a unique proximity verification ID, which will be transmitted by device 102 to device 104 to prove proximity via a direct non-networked communication e.g., Bluetooth signal. If device 104 detects this unique information transmitted by a signal such as Bluetooth, NFC, Wi-Fi or cellular signal of limited range (e.g., a non-networked connection) then receipt of this unique temporary ID 130 by device 104 will provide substantial verification that device 102 was indeed within a substantially close proximity (e.g., signal range) to device 104 during at least the signal detection step 114 and/or temporary ID transmission step 132. Here, temporary ID 130 is sent to device 102 for transmission to device 104 in a non-networked signal and optionally device 162 also sends temporary ID 130 to device 104 if temporary ID verification matching is done on device 104 itself. Optionally, device 104 may be configured to receive temporary ID 130 only by non-networked ways such as by Bluetooth, Wi-Fi and/or device 104 may be configured to take additional steps to verify that the received temporary ID 130 is received by non-networked communications.

In one embodiment illustrating the signal device 102 emits to verify proximity, once device 102 receives temporary ID 130 via 126 and 124, device 102's preconfiguration (as discussed above) may trigger transmission of the temporary ID 130 (act as an iBeacon via the iBeacon protocol) at 132. This allows device 102 to transmit a beacon signal for devices within proximal signal range like device 104. This transmission is illustrated at step 5. The transmission signal 124 maybe comprised of the temporary ID 130 itself or information based on said temporary ID 130, latitude/longitude or other location information, time, user information such as a profile/interest graph identification number, device ID, software ID, commands or any other information desired. This data may be encoded in a signal such as a iBeacon signal(s) e.g., encoded in an iBeacon signal UUID, major and minimum or other type of signal.

In one embodiment, at 132, device 102 which is an iPhone™ contains preconfigured instructions obtained from a downloaded iTunes application to transmit a Bluetooth beacon signal upon receiving a temporary ID 130 (e.g., transmitted by device 104) and/or other data such as an accompanying trigger/command (after step 124) at step 132. Temporary ID and the related data may be transmitted to device 102 from device 162 (e.g., requested by device 102 from device 162—trusted party server) or other device via a cellular network, Wi-Fi, wired connection or any other transmission tools including indirect networked signals. The temporary ID may then be transmitted by device 102 to device 104.

At 134, device 104 detects device 102's beacon signal containing POP-UUID and/or related data such as data based on the POP-UUID 130. Here device 104 was configured to listen and recognize this signal from device 102. Specifically, during the preconfiguration steps below, it is understood via the downloaded instructions on devices 102 and 104, that when device 102 receives the temporary ID 130 it will transmit it or related data in a form recognizable by device 104. In one embodiment, a prefix or other command could be incorporated in the data containing temporary ID 130 and transmitted to device 104. The prefix would be known to device 104 (from preconfiguration) and recognized as a prefix and the rest of the data may be recognized as the temporary ID 130 or other type of data desired to be recognized.

At 140, device 104 sends the received data from device 102 to device 162 for proximity verification of the received temporary ID 130 at 136. If this received ID matches the originally computed ID at step 130, then device 102's proximity to device 104 is verified at 142. In other words, if these two temporary IDs match, then it is reasonable to conclude that at least device 102 was in physical signal range/proximity to transmit a temporary ID 130 to device 104 at the transmission via non-networked communications at 132.

In one embodiment as a fraud deterrent and to prevent mistaken user mistaken identity, in order for proximity verification to occur, the ID must have been transmitted by device 102 and received by device 104, 162 or other device for verification within a desired period of time e.g., transmission 132 must occur within seconds, minutes of device 162 transmitting the temporary ID. Here, the IDs may be time stamped (e.g., time of generation, reception, transmission etc.) or otherwise associated to time so the above steps can verify proximity with substantially little time for fraud to occur.

### Proximity Verification Embodiments and Other Steps

If multiple end user devices like device 102 are in proximity around device 104, one user device can be distinguished from another during the processes shown in FIG. 1, by varying the temporary ID they are associated to. For instance, in the verification step(s) above, it can be assumed that the same end user device 102 that sent at least a substantially unique POP_UUID at 132 was the same device that was issued the same substantially unique POP_UUID at 124 by device 162. This assumption may be limited to a substantially small time period e.g., 5 seconds or other period.

Various tools can be used to conduct verification matching 142 of the received temporary ID sent to device 104 by device 102 at 140 and the originally computed temporary ID 130.

Upon verification matching, at 144, the result 146 of the above verification matching can be sent to device 104 e.g., device 104 receives the verification result at 138.

Upon successful proximity/interest verification, device 162 at 148 (or the device that executes the verification(s)) can send transaction information to proceed with a normal user logon on a merchant (e.g., grocery store) server. This may include a proximity/interest verification credential/URL string for a transaction 150 (for an end user logon) to device 102 and/or other devices such as device 104 and 106 that device 102 is in communication with. Specifically at 150, data such as a verification credential or other data may be generated and sent by device 162 or other devices. More specifically, the URL may contain at least a portion of the POP_UUID 130 (e.g., for identification purposes) and a command such as launching an app, or going to a resource location such as a login webpage on server 106. These commands may be directed to one or more applications the user has on her device 102 and may be known to the illustrated devices from the apps downloaded during the aforementioned preconfiguration steps.

At 152, device 102 may be configured (or be preconfigured from the steps above) to listen for more data from a desired device such as devices 102, 106, 162 or others. Specifically, device 102 can be configured to listen for the URL at 152. More specifically, the device may listen and recognize for a string transmitted to it with at least a portion of the POP_UUID 130, which lets the device 102 know the string was meant for it instead of other devices in its proximity. The sent verification credential/URL string and/or other data at 148 can be configured such that these other devices can now communicate with device 102 with assurance that device 102 was in the desired proximity of device 104.

In addition, given the verification(s) have succeeded, device 102 may optionally now discard POP_UUID 130 at step 154 given that a different proximity/interest verification credential may have been issued above at 148.

The issued verification credential/URL string assigned to device 102 above can then be used in substantially secure transactions such as a web login session 156, 158 and 160 with device 104, 162 and 106 or any other device needing verification. This may include launching an app or prompting the user of device 102 to log into (e.g., with a password and user name) an end user account on a merchant server to get customer loyalty points, buy goods/services etc.

For example, at 158 an interaction with device 102 may occur with the other illustrated device(s). An interaction such as web session 156 with a website 160 may occur and in one embodiment, which may allow device 102 to interact with device 106 at 162 and other desired devices who have received verification that device 102 is in proximity to device 104.

### Additional Embodiments of Proximity Verification

In one embodiment, as an anti-fraud mechanism, the location verification steps above can be attempted only a limited number of times (e.g., one proximity verification per day) per end user account. This would prevent a thief from continuously verifying location and getting rewarded thus abusing the merchant e.g., continuously getting reward points for imitating entry into the same grocery store thousands of times per day.

In another embodiment, a picture of the device's owner (e.g., from the device 102's photo gallery) or other visual identifier such as from a previously set-up end user account can be sent to device 104, 162 and/or 106. This picture may be associated with a temporary ID 130 (e.g. sent to device 162 at step 118). From this, a merchant employee looking at the display of one of these devices can visually correlate from the user's photo or other identifier (such as a name, phone number, loyalty card number etc.) which of the various end users just verified its proximity. Then the employee may then select via clicking of the picture of the owner holding the device. This confirms that among the various devices in the store that may have just confirmed their identity, that the employee can then select the correct device given the physical appearance (ID) of the owner holding the device. Selection of the end user device by the employee can specifically reward customer points, launch an app, webpage, initiate a financial transaction etc.

In one embodiment, the transmission steps 115 and 132 and detection steps 114 and 134 use their respective device displays to display QR codes and the detection of said codes with their respective device's camera. This embodiment thus shortens the distance device 102 and device 104 need to be in as it is limited to visual range of the device's camera's as opposed to a Bluetooth or other radio signal range that is non-networked.

In one optional embodiment, a token/other desired information can be included in the beacon signal that device 104 transmits at 115 or other steps. This may be done at 124. For instance, the latitude or longitude or other representation of the position that device 104 was assigned to be positioned in geophysical space can be transmitted (e.g., geophysical coordinates associate to the beacon as entered in device 162). This can be later matched with the location (optionally transmitted by device 102 to one of the devices in FIG. 1) of the end user device 102 receiving the transmission to ensure the actual geophysical placement of device 104 is correct. This is accomplished by matching the location assignment if the UUID/maj/min that was preregistered on a remote server (e.g. device 162) to that of location information an end user transmits when she detects the device 104's signal (device 102's GPS data etc.). For instance, if a device 104 which was supposed to be placed in Seattle (and its UUID was registered/associated on the Starbuck's server 162 as being in Seattle) but is interacting with location data sent from end users' GPS coordinates in New York, indicative that device 104 was accidently deployed to New York and not Seattle. The end user GPS data may be sent back to servers at 118 or other steps.

In yet another embodiment regarding preconfiguration, as discussed in previous patent applications, the downloaded app or other data on device 102 may then help determine/rank a user's interest in particular beacon and related data (associated beacon goods and service tags). This may be done by the app generating a table such as table 300. Specifically, an application doing brand sorting which is used to create a profile and rank content/offers and other data based on the user profile.

More specifically, the device may help present, gather and/or process end user brand preferences, user inputs and information into an interest graph or profile. This user profile data may be used to rank beacons (such as those in a ZIP code where the user is present) into a ranked list according to likely end user interest with relevance scores etc. This ranking may be done by considering tags and other information associated to the beacons to those tags and statistical probabilities associated to a user profile.

Table 300 in FIG. 3 illustrates a sample table of such ranked beacons from those beacons physically located in ZIP code 98103 as discussed in previously filed patent applications. This table could be calculated locally on device 102 or remotely.

In the above embodiment in FIGS. 2 and 3 specifically device 104, an iPad™ may be configured as a POS (Point of Sale) machine with various apps installed which enable configuration and is physically deployed at a merchant's physical retail location. The apps may be configured to transmit data like that in table 204, to communicate with device 162 and 106 over a network as well as process end user credit card payments etc. Device 104's properties such as related data/services/location etc. may also be registered with various servers like device 162 and device 106. As discussed in the above reference applications, device 104's properties can be registered with a device like device 162 such as its beacon ID which is associated to the beacon's goods/service/data tags associated to it etc. An example would be a beacon ID that is registered to a Starbucks™ is associated with tags representing coffee, tea, location address such as Seattle, Yelp™ reviews etc.

In one embodiment, trusted party server 162 may also be configured to interface with the various devices in the figures. Specifically, it may be configured to be referred to by the app downloaded from iTunes™ by device 102 as discussed in the above referenced applications (e.g., to issue Temporary ID 130 upon device 102 request). More specifically, the application installed on device 102 communicates with device 162 which may contain the end user's interest graph/profile. In addition, devices such as device 104 (or beacons associated to device 104) may be registered with device 162 for recognition and communication. As previously discussed, upon device 102 detecting the beacon information emitted by device 104, device 102 may communicate this to device 162 to confirm interest in the beacon and associated goods/services tags.

In yet another embodiment, proximity verification party sever 106 (e.g., the Merchant's Server) may also be configured to communicate with all or some of the devices mentioned above. Specifically, once verification of the end user's identity and/or interest is confirmed, device 106 may then process verification credentials issued to device 102 and continue with a transaction such as awarding customer loyalty points, etc. Device 106 and device 104 may be separate computing devices or the same computing device.

As illustrated in FIGS. 1-3, the communication of the temporary ID 130 or any other data maybe communicated to the illustrated devices by associating the data with a device IP address, MAC address, DNS address, software ID, phone number or any other data to help facilitate communication.

Toolset #2: Leveraging iBeacon Signal Data Customization Tools Via End User Device Awareness and Personalization Tools
iBeacon Data Signal Customization Overview

As introduced above, better and more relevant suggestions of content and actions appropriate for a user's proximal environment can be determined if better context of their surroundings can be determined. This is because personal and central devices can be configured to communicate to proximal devices information including their properties to better make decisions while maintaining user privacy while minimizing configuration and user confusion.

As such, tools are discussed which solve the aforementioned contextual deficiencies with customized signals such as customized iBeacon signals. These customized signals can provide information about proximal both device properties, associated users, available content/actions, range, ownership etc., for both personal and central devices. For instance, one of the disclosed embodiments computes relevant suggestions for group TV watching comprising the user profiles of proximal users and the characteristics of the TV (screen size) which may be broadcast at least in part by each respective device.

In one embodiment, a central device may be a device useable by a plurality users simultaneously such as a large screen TV, stereo, car radio with Bluetooth/Wi-Fi, game console, audio speakers with Bluetooth/Wi-Fi capability etc. In one example, a central device may be a device that has a diagonal screen display over 20 inches or weight over 12 pounds. In another example a central device may be a device that is accessible (e.g., will accept commands from) by a plurality of users simultaneously e.g., users may simultaneously input data in it. This might be a device that is not currently registered exclusively with one user (which excludes commands from another user).

In one embodiment, a personal device may be a device that is typically accessible only by a single user at a time e.g., an iPhone, tablet, laptop computer etc. In one embodiment, the primary display is only accessible by one user account at a time e.g., an iphone with a user currently logged in or a laptop with a user currently logged in.

Any signal from any personal or central device may be customized and used as described below such as signals transmitted via iBeacon protocols, other Bluetooth signals, Wi-Fi signals, NFC (Near Field Communication) signals etc. Specifically, data transmitted by the aforementioned technologies can be customized to reflect information about a central device and/or a user's personal device (such as device capability/type/properties/associated user profiles etc.). In turn, this data can be used to determine more the devices in proximity and thus determine better proximal context.

For instance, the proximal context of a personal device can be determined by detecting the capabilities, properties and associated content of devices around it such as a central IPTV device sending a customized data signal reflecting such properties. In one embodiment, the signal may comprise or be determined based on the customized signal: screen size, operating system, installed software, present/past connected devices, present/past connected users, present/past networked devices, speaker type, audio/video channels, network information, ownership information, end user profiles associated to it, other devices connected to it such as peripherals (e.g., webcams, Microsoft Kinect™, microphones etc.).

In one embodiment, this information is used to compute the context that each of the devices within a certain proximity contributes. The context is then used to suggest to proximal devices relevant actions/content/brands/ads available through or using these devices e.g., such as suggesting to a smart phone user of the availability of a Netflix™ Movie associated to her Netflix account in the cloud that all the proximal users would want to watch it plus it may be displayed on a proximal 60 inch screen IPTV. In this example, said suggested TV show being suggested because it has a certain substantially high resolution to take advantage of the substantially large central IPTV display In addition, the suggestion was also based on a composite of TV show preferences of a plurality of proximal users, which was created by aggregating portions of the proximal user profiles associated with their personal devices.

Customizing iBeacon Data Signal to Reflect Properties/Characteristics of Devices and Users in Proximity to Each Other

### Customizing Device Data Signals

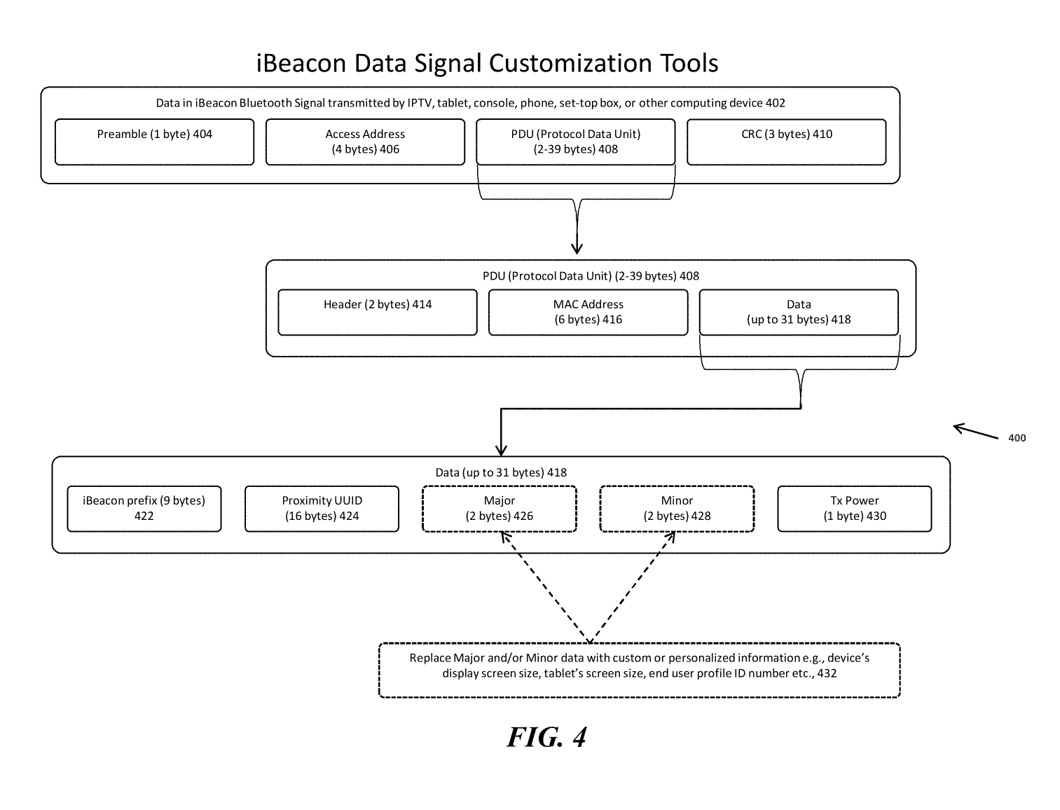

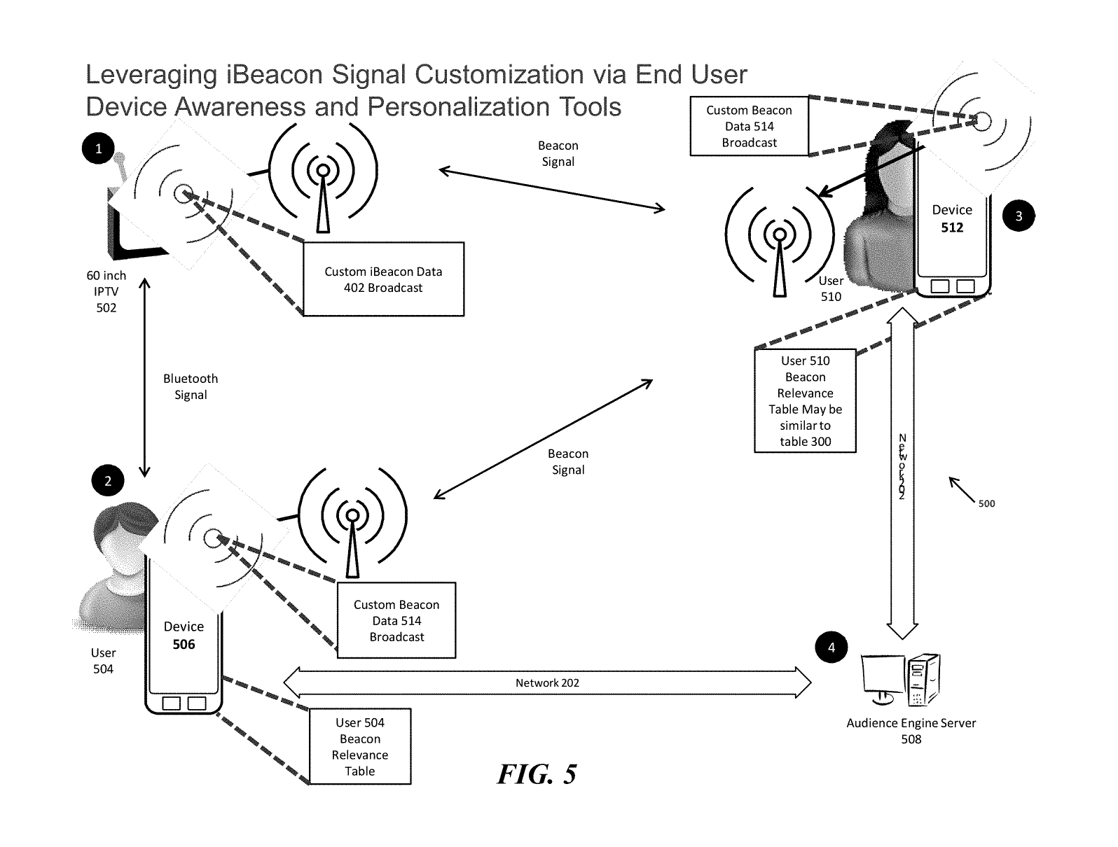

Customized beacon (e.g., iBeacon) data or other signal data can greatly aid in communicating contextual data to proximal devices. In one embodiment, such as shown in FIG. 4 and FIG. 5, iBeacon data signal/Bluetooth LE signal data is customized to at least indirectly reflect device characteristics (capability/properties/type/ownership/associated data such as user profiles). This customization may occur on a user device and/or central device. Any signal types, profiles and/or protocols such as NFC, Bluetooth LE and Wi-Fi can be customized in a manner similar to FIG. 4. As illustrated, an iBeacon signal's range information and identity information is supplemented to include additional information about the transmitting device.

In FIG. 4, which illustrates embodiment 400, a Bluetooth iBeacon in IPTV 502 is configured to broadcast the Bluetooth LE data packet in FIG. 4. In one embodiment, this data is the iBeacon protocol data. In addition, the beacon can separately transmit pairing data when not transmitting protocol data (transmitting profile data at certain time intervals and protocol data at others).

Data 402 may be transmitted by an IPTV's Bluetooth radio or other computing device such as a tablet, console, set top box etc. The beacon may be configured to send a one way signal (not configured to receive signals back) or configured as a two way beacon (configured to received signals back). Typically, iBeacon signal data may be comprised of a preamble 404, access address 406, PDU (Protocol Data Unit) 408 and CRC 410 (Cyclic Redundancy Check). In this embodiment, PDU 408 is created/configured to contain customized device data. The PDU may comprised of Header 414, MAC address 416 and Data 418. In this embodiment, Data 418 of the PDU 408 may be customized.

Data 418 of PDU 408 may be comprised of iBeacon prefix 422, Proximity UUID 424, Major 426, Minor 428 and Tx Power 430. Here, Major 426 and/or Minor 428 may be customized to contain other/additional information. For instance, instead of major 426 broadcasting a typical major value, the memory that typically contains major 426 can instead be changed to broadcast “type=1” or other data 432 that may reflect on the broadcasting device's capabilities/properties or other characteristics as desired. For instance, “type=1” may stand for a large screen TV with at least a 60 inch display which maybe the actual property of the device transmitting this customized signal. Any type of desired designation/taxonomy/nomenclature may be used to indicate the device's capabilities/properties or other properties such as a profile ID associated to a user, location information, restrictions of the device etc.

The above-mentioned 60-inch IPTV central device may transmit this signal via Bluetooth radio or cause another device to transmit this signal. A receiving user device such as proximal personal iPhones detecting this data may be preconfigured to recognize that “type=1” is not a “Major” value as in typical iBeacon signals but rather it is a property reflecting a 60 inch TV screen size. The detecting user device may be preconfigured to recognize this property via downloading an application from the iTunes or Google Play store or via configuration of the operating system of the device or other methods.

An example table is provided in Table 606 for determining devices properties/characteristics in relation to the data they transmit. In this example, the personal device is configured by the downloaded application to listen for beacon signals containing certain values in tables that maybe downloaded with the application (as discussed below) or otherwise accessed by the device application/operating system after the application is downloaded on the user's device. Such a table might include Type=1, Type=2 . . . Type=n, in which the downloaded tables may contain corresponding indications of the type of hardware/characteristics or other properties each type defines e.g., Type=1 defines a display with 60 inch display, Type=2 defines a display with a different inch display etc.

The transmitting device such as IPTV 502 may itself be configured in various ways to send the above customized data signal in FIG. 4. This may be done by the IPTV downloading an application from iTunes, Google Play or other tools. In one embodiment, the central device may come from the factory configured to transmit desired properties.

### Leveraging Customized Beacon Data for Proximal Context/Relevance Scores

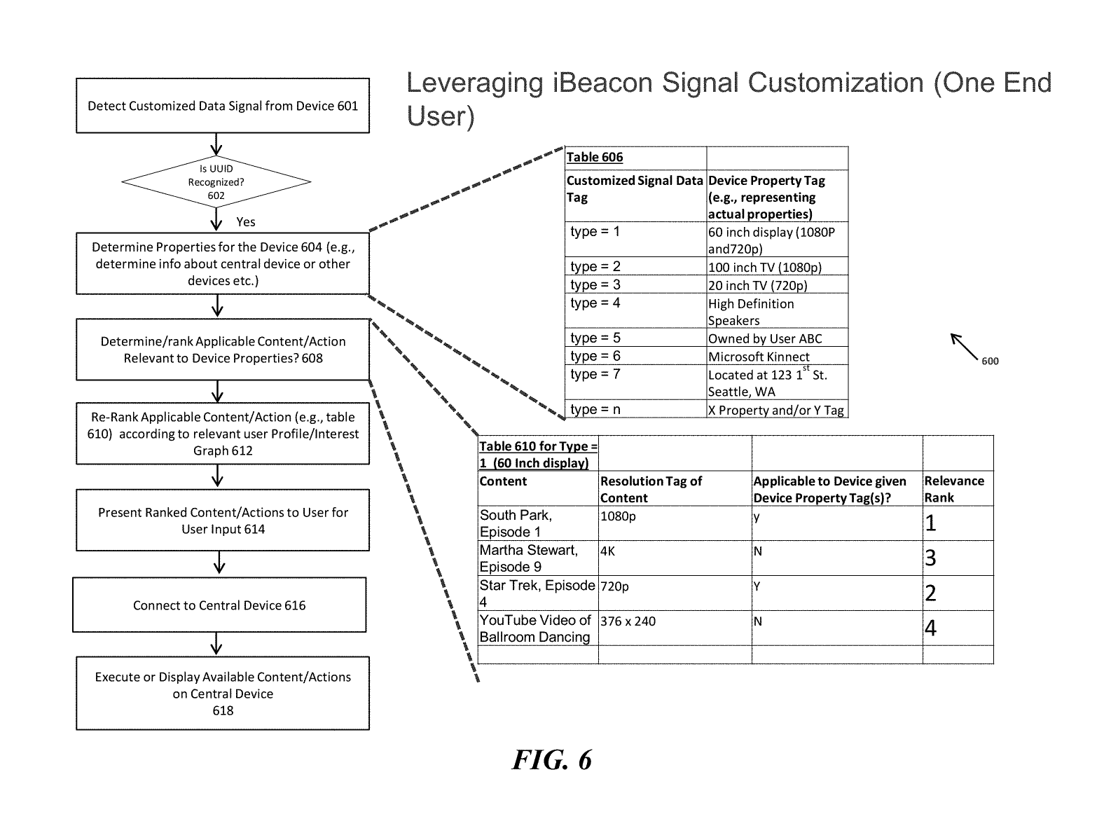

As discussed above, proximal receiving devices can use customized iBeacon signal data in a variety of ways. For example, the customized data from a central device may be used to calculate enhanced content relevance scores to provide better contextual suggestions to proximal personal devices as illustrated in FIG. 5 and FIG. 6.

In embodiments such as these, relevance/interest scores based at least in part on customized proximal beacon data can be assigned not only to content such as TV shows but also to devices themselves including central devices such as TVs and personal devices themselves. In FIG. 5 and FIG. 6, customized iBeacon data of devices proximal to a first user device can be used to calculate the relevance of devices to other devices e.g., in light of its associated user profile, is device X relevant to device Y and if so, then by how high is the relevancy score? Then, relevance scores may be calculated for available content/actions/data/goods/services/recommendations/devices based on the above the relevant devices in proximity and other factors.

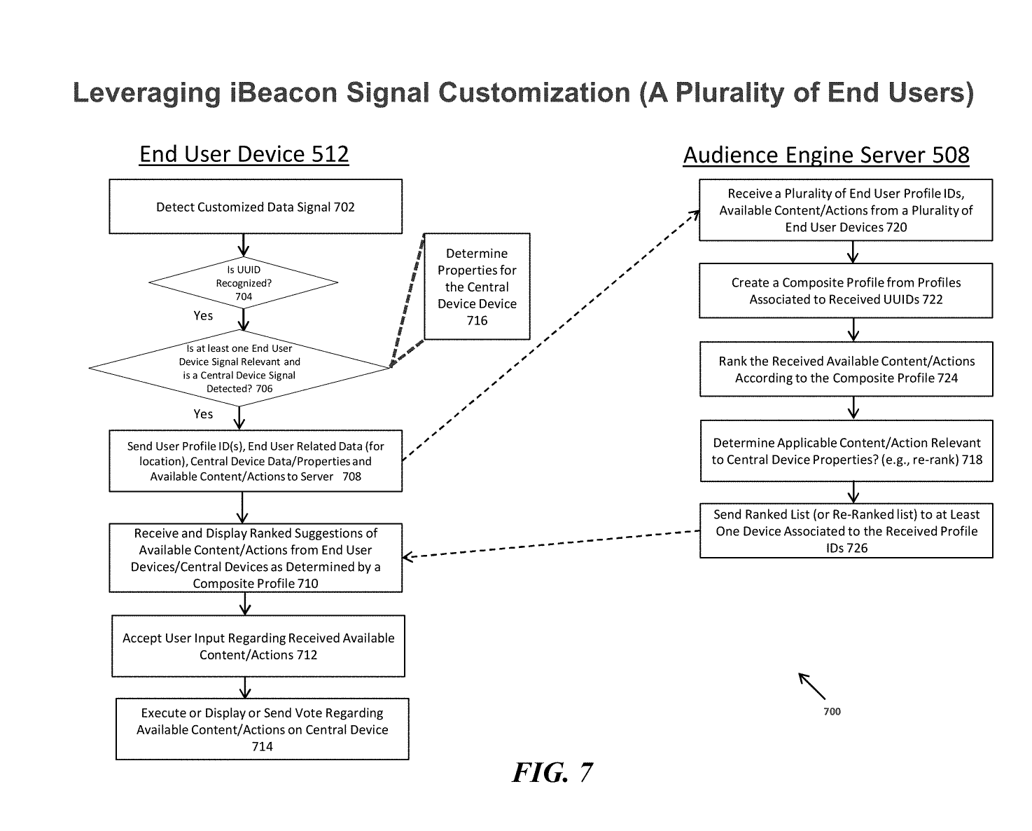

FIG. 5 illustrates an embodiment 500 for calculating a relevance score for the IPTV 502 or (other customized signal transmitting device) for use by proximal receiving device 506. This is continued in FIG. 6. In addition, FIG. 5 also discusses how device 512 or a device in communication with it, calculates the relevance of device 506 and device 502, which is discussed in FIG. 7.

### Determining Relevancy Between a User Device and a Central Device

Discussed first will be calculating the relevance between IPTV 502 (e.g., a central device) and device 506 (e.g., a user device). At step 1 in FIG. 5, IPTV 502 transmits a customized iBeacon data signal 402 such as that in FIG. 4. The custom iBeacon data signal comprises data such as that in data 432 (see FIG. 4) that reflects it's screen size is 60 inches (e.g., “Type=1”) or other desired information. Also optionally included in the customized iBeacon data signal is Proximity UUID 424 which may identify device 502 as a TV and other desired info such as attached peripherals (e.g., Apple TV, Microsoft Kinect, game console, satellite dishes etc.), user ownership information, cable TV channels that can access, networked devices, and other desired data. Device 506 may be preconfigured to recognize such a UUID or other broadcast data similar to the data discussed above. Device 506 may be configured to execute such recognition with or without a server lookup/table lookup after receiving the data similar to that in FIG. 4.

Preamble 404, Access Address 406, CRC 410, PDU 408 and the remaining elements optionally aide in identifying the data signal as a iBeacon signal as per the iBeacon signal protocol.

As device 506 (e.g., a smart phone) enters physical proximity (signal range) of IPTV 502's signal 402, IPTV 502's customized data signal is detected by device 506's Bluetooth or other signal transceiver. As introduced above, device 506 recognizes the IPTV's customized iBeacon data signal via pre-configuration executed by an application downloaded from the iTunes Store, Google Play, or other tool in which it was instructed to listen for certain data like that in signal 402.

Specifically, device 506's preconfiguration listens for and recognizes IPTV's custom data signal as an iBeacon signal which has at least part of its UUID belonging/associated to that of an IPTV or other device it is instructed to look for (this may be pre-registered in the application 506 downloaded from iTunes or determined from a server lookup at anytime) and/or also recognizes that Type=1 in data 432 is a 60 inch screen and/or the Tx Power 430's given value. The associations above may be from a table that is downloaded from iTunes such as the table in FIG. 6 or accessed by other tools.

After receiving the customized data, device 506 (itself or a networked device such as audience engine 508) can then decide if the central device properties as determined from the customized data signal are substantially suitable/relevant to itself/its currently associated profiles and data; as well as optionally to other proximal devices which is discussed in FIG. 6.

One such example of the former, is determining if the IPTV 502's properties, as determined at least in part from the customized data signal, are relevant to the device 506 and its associated data/devices such as TV shows (and its tags) accessible on device 506, e.g. via ranking/considering the IPTV characteristic tags (resolution tag) and TV Show tags (content resolution tags) via a table such as tables 606 and 610. Any such attribute tag of device 502 or other devices or associated data can be used as above and considered.

In one example in FIG. 6, system 600 which may occur on device 506, shows the above steps triggered via detecting a customized data signal from the IPTV 502. Here, device 506 will determine the relevance of itself/associated devices and/or data in relation to IPTV 502 and its customized data signal. First, device 506 detects the customized data signal at 601 when it enters proximity range. At least part of the signal from 601 is recognized by device 506 at 602. Then at 604, the properties and associated data for the central device are determined based on the data in device 502's custom data signal. These may be obtained via downloading Table 606, which may be downloaded by device 506 in an iTunes application. Here in table 606, detected data “type=1” is associated to a device property tag “60 inch display”. In addition, the detected UUID and other data in the customized signal can be associated to other tags via a similar downloaded table or a server lookup can be executed passing at least portions of the received customized signal data from the IPTV 502 on to a server to get associated tags. Such characteristic tags such as device ownership, location information, associated content, attached peripherals and other information can be determined by this manner of matching tags to information based on customized signal data.

In the above example, the tag “TV” as determined from the UUID and “60 inch display” as determined from the data in the customized signal (date 432) are used in a relevance determination with device 506 at 608.

At 608, the relevance of applicable content/actions and/or other information about device 502's properties/property tags are determined. For example, in table 610, the TV show “South Park” is ranked very relevant in relation to the properties of the IPTV 502. This is determined by substantially matching (e.g., threshold matching) or associating appropriate tags (e.g., via taxonomy or marketing data) of TV Shows (which may be pre-tagged) with tags determined from the customized data signal of the IPTV such as those from table 606. For instance, the tag “South Park” and the tag “60 inch TV (1080p, 720p)” are associated by matching/associating tags of table 606 and 610. For instance, during tag and table creation, “South Park” and “1080p” may be associated to “type 1” TVs given that the substantially large TV display is substantially suitable for 1080p TV shows. A tag of “applicable” to the IPTV 502 may be assigned to appropriate content/actions in a user's profile or other file.

Based on the above data, device 506 may conclude if the content/actions associated to device 506 are substantially suitable/relevant for the properties of the properties of the IPTV hardware. Relevancy score/ranking of content and actions can be done in several ways such as number of tags in common between content/actions and device 502's properties and tags as determined from the custom signal above. In one embodiment, the detected Tx (power; indication of range) as detected by the user device may also be used to determine suitability/relevancy e.g., determining if the IPTV even within suitable range of device 506 for the pertinent relevancy determination etc.

The content/actions/other data examined (as seen in table 610) may be located on the device 506, or otherwise accessible to the user such as on a remote network e.g., iTunes movies he has paid for and stored on a remote server etc. or otherwise associated to the user/device. Device 506 or a server can assign tags to the content as needed.

At 612, the content in table 610 is optionally re-ranked a second time according to the user's profile. Here, assuming the user of device 506 is a typical American male, he would likely want to see a high resolution episode of South Park before a low resolution video of ball room dancing (or a high resolution video of ball room dancing). Here one or both of the resolution and type of TV show may have also influenced these rankings. Vector ranking via tags as discussed in the above referenced patent applications may be used for ranking the actions/content along with other factors such as location, time, holidays, weather, a user's profile/interest graph and additional factors as discussed below. If the actions/content are substantially suitable/relevant (e.g., from a relevancy score or equals or exceeds a threshold relevancy score), then the resulting actions/content may be designated as such (e.g., tagged “suitable”) and ranked accordingly. In one embodiment, available content/actions may be first ranked by the factors above and then subsequently ranked according to the data determined from in the customized signals. Various weighting methods may be used in ranking.

In one embodiment, a relevance/ranking score may consider, the IPTV's “Tx” Power 430 (which indicates the range of the IP TV from the receiving device), the capability of the device 502, other data received/associated to the receiving device 506 (e.g., identity, UUID, type, properties, capability, profiles associated to those phones/tablets, files accessible, social media accounts, Netflix or other media accounts etc.), the time of day, the profile of the user using the receiving device, the user's past location/browsing/purchase history, the date, the weather conditions etc.

At 614, the ranked content or other data may be presented to at least one user such as the user of device 506. The content that meets a desired threshold ranking may then be brought to the attention of the user 504 via device 506 or other device such as IPTV 502. For instance, device 506 may display “would you like to watch South Park in high definition on a big screen TV? Swote Input up for “yes, Swote input “down” for no”. The user may then input his desire and the result recorded into his profile for execution and/or later analysis and considered in her user profile. If “yes” is input, then the content may be displayed or otherwise use the IPTV's capabilities.

At 616, assuming the user has selected a “yes” on one of the presented content items, device 506 or other connected device with access to the episode of South Park may connect to the central device 502 to play or otherwise utilize the selected content at 618.

In one example described, the software on the user's device takes into consideration information included in customized beacons from device and/or other users in proximity when analyzing recommended actions. In the above steps, a third device such as server may be involved. Otherwise, these steps may occur only between device 506 and the IPTV.

### Leveraging Ibeacon Signal Customization Between a Plurality of Users (Case #2)

Another way to leverage customized data signals is to examine customized data signals of a plurality of end user devices and optionally those central devices as well or any combination of these. Examining proximal user devices adds an additional layer of proximal context to help suggest relevant actions/content that the plurality of the proximal users would likely be interested in. For example, the proximal users may want to get the relevant content/actions for use on the central device e.g., movies that all or substantially all the proximal users would likely be interested in that would be substantially appropriate for the properties of the IPTV 502.

As illustrated in FIG. 5, an example may be end user device 512 determining relevancy between not only it (and associate devices/data) and central devices like IPTV 502 but also between it and other user devices like user device 506 and its associated devices/data. In one embodiment, there is likely contextual relevancy between user devices if the user profile (or associated data/devices) associated to a user device 512 is relevant to another user profile (or associated data) associated to the other user device 506. For example, relevancy between user devices may be determined by substantial similarity/ranking/matching of shared interests and/or characteristics between the users or other data associated to the users. In one example, if the different device users are family members, then they are likely relevant to each other, if they are complete strangers, then likely irrelevant to each other. Another might be if the users have a shared interests/tags with substantially similar interest levels/usage rates, substantially similar usage patterns, similar associated content etc.

Upon a determination that user devices are indeed relevant to each other, the customized signal data from the user devices and the customized signal of a central device 502 (as well as associated content/actions) can then be used to determine if the central device as well as content/other data accessible or associated through the various central and personal devices are relevant to the proximal context. These steps may consider the relevancy of at least portions of the user profiles and characteristics associated to the above devices.

FIG. 5 illustrates an embodiment of a user device 512 first determining if the other user device 506 is relevant to it. This may start when device 512 detects a customized beacon data broadcast 514. The customized data broadcast by device 506 may be configured by device 506 in a similar manner as described above for IPTV 502.

In this embodiment, the customized signal data from device 506 can be analyzed at least in part by device 512 to determine relevancy. Device 512 may be preconfigured similar to that discussed above in order to recognize a UUID or other customized signal data transmitted by device 506. Device 512 may be preconfigured to distinguish between UUIDs or other data from personal devices as opposed to central devices.

The customized data broadcast 514 may contain or be associated by device 512 (e.g., via a server lookup) with a variety of data such as: if the device 506 was added to a “favorites” list by the user of device 512, if device 506 was detected frequently in proximity to device 512, if device 506 has interacted with device 512 previously, if device 506 has an associated profile/ID or other data that is similar or the same to that associated with device 512, if device 506 is frequently on the same local network as device 512, if device 506 is frequently in the same geophysical space as device 512, if device 506 is associated to substantially similar interests/characteristics/content/brands/movies/TV Shows/music/SMS/email/pictures/devices/locations/purchase history/browsing history as device 512, if device 506 is associated to substantially similar portions of an interest graph/profile as that associated to device 512 (substantially similar interests and associated statistical probabilities) etc. Additionally, 506 may be configured with a variety of commands to execute upon detection of certain customized data such as the above determinations of relevancy. In addition, upon a determination of relevancy, one or both users may be asked to confirm relevancy.

Once it is determined that device 512 is relevant to device 506, then associated user profiles or other data associated with users 510 and 504 may be combined to form a composite profile/rankings with the tools discussed below. These composite profiles/rankings will be used to determine content/actions that both users would likely be interested in that may also involve the properties as associated from central device 502's custom signal.

For instance, once content/actions from the user devices/profiles are determined and ranked, the list can be re-ranked according to data from proximal central devices such as IPTV 502 (similar to that as illustrated in FIG. 6). As in FIGS. 5-6, additional factors may be used in the ranking above including holidays, availability and other factors as discussed below. The resulting ranked actions/content may then be presented to the user(s) and executed or otherwise utilized on the central device or other device.

### Exemplary Embodiment of Leveraging Ibeacon Signal Customization Across a Plurality of Users

FIG. 7 illustrates the above processes in more detail as steps 700. At 702, device 512 detects a customized data signal 514 from an end user device such as device 506. The customized data signal may be in a format similar to that illustrated in FIG. 4. In one embodiment, the UUID or other part of the customized signal may be customized to indicate if the signal is from a personal or central device, the type of device, a user profile, a user ID or other information that will help give proximal devices contextual information. This customized information allows a detecting device such as device 512 to quickly determine information about device 506 without the delay and computation burden of requesting this information from a server. (Although a server lookup to get the above or additional information can be optional). In another embodiment, device 512 is configured to determine if the device is a central or personal device by examining the custom signal information e.g., a device with a diagonal display that is over 20 inches, may be designated a central device etc.

Device 506 can be configured to broadcast custom signal 514 by an application downloaded from iTunes or other manner similar to that described above in relation to FIG. 4 and FIG. 5.

In this embodiment, the user of device 512 has previously detected and added device 506's UUID as detected from the custom signal 514 to a “favorites” list at step 704. (In this embodiment, the device 506 actually belongs to a family member of user 510.) The previously added favorite UUID is matched with the detected UUID of device 506 and is thus recognized by device 512 as a relevant device to user 510. This occurs at 706.

Also at 706, a central device's custom data signal is detected and determined to be relevant (similar to that illustrated in FIG. 6), its property tags and other associated data may be determined from a custom signal. This may occur at 716. Then, this central device data may be used at 718 pertaining to available content available to it and device 512. In one embodiment, a personal or central device may detect other device's signals (optionally whether they are acting as personal or central devices) and send this list to an audience engine server or otherwise use this list in the following steps e.g., step 710 to help determine what available/content actions there are as well as presently logged in users there are along with their profiles.

In one embodiment to determine if device 506 is relevant to device 512, a user profile similarity determination may be done as discussed above. For instance, the custom signal 514 may transmit a user profile ID number other data associated to the user. Here, device 512 may detect custom signal 514 and a determination can be made from the profile associated (or other associated data) to device 506 to determine if the profile associated to device 506 is relevant to the profile associated to device 512. This may include a server request for more information via audience engine 508. Relevancy can be determined in a variety of ways such as substantially similar name, location, interest/characteristic information associated statistical probabilities of these, combinations of these etc. Device 512 may be preconfigured for the steps above via an application downloaded from iTunes or other steps as discussed above. Relevancy may also be done at least in part on audience engine 508. Threshold matches (e.g., +/−5% similarity), taxonomy, marketing data matches and other tools may be used as well.

At step 708, at least one of the user profiles/profile IDs (associated with device 506/512) or other data associated with the user devices is used to create a composite profile/ranking for the users 504 and 510. In this embodiment, device 512 sends at least one user profile ID number associated to an audience engine server 508 (e.g., the profile ID of user 510). In addition, device 512 could send a user profile ID number associated to detected device 506 to audience engine 508. Device 512 could have previously stored this information or device 506 can be triggered by device 512 or server 508 to send its user profile ID number upon detection of device 508's signal by device 512.

In place or along with the user profile ID number, the profile itself, available content/actions, and other information such a UUID, a login (iTunes account, Netflix account etc.) characteristics/brands/interests content, IP address, MAC address, software ID, content/action tags or other tags, content/actions available on IPTV 502 or any other data can be used to aid in determining composite profiles and rankings. In this embodiment, this data is then used by the audience engine server 508 to determine a composite profile/ranking for the users and determine available content/actions and other data that may of interest to these users. In other embodiments an audience engine and at least one of the user devices may execute all of part of the steps above.

Once audience engine 508 receives the associated user profiles and optionally, the content available to devices 506 and 512, the audience engine may create a composite profile. This is illustrated at 720 and 722. The composite profile will be used to determine content/actions that both contributing users will likely be interested in given their profile and other factors discussed below (e.g., time of year/weather etc.). A variety of tools may be used to create said composite profile/ranking as discussed in sections below. In one embodiment, the same or similar characteristics/interests (e.g., represented as tags) and associated statistical probabilities (e.g., 50% associated to the tag “male”) from both user profiles may be combined in any desired fashion e.g., averaged together, weighted or through other calculations to create a composite profile (e.g., both users have the “male” tag and their associated statistical probabilities are combined (50%+21%). Additionally brands associated to each profile may be used to predict additional likely user profiles characteristics/interests as described in the above referenced patent applications.

In one embodiment of creating a composite profile, the characteristic “demographic 10-15 yrs” is chosen in the composite profile and represented by a tag and associated probability. One user (who is in reality 50 yrs. old) has that characteristic in his profile as well as an associated probability of 1%. Another user who is in reality in that category has that same characteristic in her profile and has that associated probability of 99%. The characteristics and probabilities are averaged or otherwise combined together in a composite profile into a single value.

In another embodiment illustrating composite profiles, user 504 has a strong dislike/statistical disinterest probability for Italian cooking shows in his profile while user 512 has a strong dislike reflected in her profile for American cooking shows. However both users have a slight affinity for Chinese cooking shows. These affinities may be reflected in the composite profile and shows selected based off at least this. As such, available Chinese cooking shows on devices 506 and 512 may then be ranked above the American and Italian cooking shows for viewing.

More specifically regarding the above example, the composite profile/ranking is then used to suggest content or other data that is accessible via the devices 512 and 506 and even content accessible via central device 502. In one embodiment, content accessible/available or otherwise associated to the users devices and the central device, such as content on their iTunes/Netflix account, local media, devices in substantial proximity to the user devices and/or central devices (e.g., within signal range) etc. is transmitted or otherwise made known to audience engine 508 or another device and ranked similar to the manner discussed above. In this particular ranking, ranking may be done in light of the composite profile/rankings. In this embodiment, the available content/actions/data associated to the user and/or central device are transmitted to the audience engine server to be ranked in light of the composite profile (embodiments discussed below e.g., at step 720 and 724). A table like that of Table 300 can be produced with relevance scores and is discussed in the above referenced patent applications.

In addition as illustrated at 718, ranking may consider the properties/associated data of the IPTV 502 or other detected central device. At 718, the composite profile/rankings can optionally then be re-ranked in light of proximal central devices similar to a manner discussed in FIG. 6. Specifically, the audience engine may rank the content/actions/data associated with the devices according to their suitability for use on a central device (is the content high enough resolution etc.) in light of the determined properties of the central device. For example, the ranked list of cooking shows created above may be re-ranked depending on the cooking show's resolution considering the properties of a proximal central IPTV by creation of tables similar to tables 606 and 610 such as 1080p display would display 1080p content better than 720p content etc. A table like that of table 300 can be produced here as well and ranked in order of relevance scores.

In some embodiments, these steps may be done on a combination of any of the above devices.

In some embodiments ranking 718 may occur before ranking 724. For example, ranking via the composite profile and other mentioned factors such as the whether and composite profiles may occur after ranking in light of the central device suitability occurs (after a central device is detected and recognized as a central device and property/characteristic tags determined).

Instead of ranking, filtering according to the suitably of the central device tags and/or composite profile can be used at any of the steps disclosed herein in any combination.

In some embodiments, the user devices or other devices may execute all or some of the steps above.

At 726, the ranked results of the steps above are sent back to device 512 (at least one user device). At 710, device 512 receives said ranked results. Said results may be displayed on device 512, IPTV 502 and/or device 506 for user input/voting at 712. This may be sent to audience engine 508 for processing. The users may also chose to execute the content/actions which is executed at least in part using central device 502 e.g., the TV show that both users want to watch with a resolution appropriate for the IPTV display size is displayed on IPTV 502.

Comparison of FIG. 6 and FIG. 7: As introduced above, the embodiment of FIG. 7 (2 user devices and a central device) has similar tools to the embodiment of FIG. 6 (1 user device and a central device). FIG. 7 will be recapped with this in mind: at 702 and 704 device 512 and/or 506 may have detected and recognized the custom iBeacon signal 402 from IPTV 502 and each other (recognized and recorded them as personal or central devices) and transmitted detected custom data to audience engine 508 (similar to 601, 602); at 716 device 512 with optional help of audience engine 508 causes the determination of the properties for the IPTV 502 (604); at 708 device 512 sends the available content/actions, profile IDs and other data such as detected devices and their information (e.g., IDs, part of the custom signals detected to determine if they are central or personal and other info etc.) to the audience engine 508 for a composite profile/ranking creation; at 710, received the ranked content/content from the composite rankings discussed above (similar to 608); at 724 reranked the composite ranking according to central device properties (similar to 612); at 712 present the applicable ranked composite rankings to at least one of the users 504/510 for voting/execution and upon appropriate user input connected or enable connection to central device (similar to 614 and 616) and execute or display content/actions on the central device (similar to 618) or input of voting to the audience engine.

Remote control Embodiment—in one embodiment if the included actions above include taking actions such as changing channels on a TV, stereo, console or taking other actions by the users above, before the action may execute, first it is verified that the user's device is in substantial proximity of the device the action will be executed on.

In another embodiment, central devices may execute some or all of the functions that personal devices did in the above embodiments. For instance, customized beacon signals (like those in FIG. 4) may be transmitted from personal devices (like device 512) and/or other central devices. These customized beacon signals can be detected by a first central device such as a smart TV (like device 502). Specifically, a personal device's signal may be customized as above to indicate/reference a profile ID and/or the device's properties or other data such as available content/actions/profiles. This may be broadcast by a personal device and received by a first central device. The first central device may be configured to recognize customized personal device signals (e.g., downloaded an application) in a manner similar to that above.

Similar to FIG. 6, the first central device can locally or with the assistance of an audience engine server (e.g., received by the first central device and sent to a remote server such as audience engine 508 for whole or partial processing) in a manner similar to the above embodiments, determine a personal device's properties, associated profile or other data from the customized beacon signal such as associated content/actions, then determine relevancy between any detected personal/central devices and/or their associated profiles, properties or associated data like content/actions in light of the first central device profiles, properties or associated data, rank/re-rank the content/actions (like in FIG. 6 step 612) in light of the first central devices properties and/or profiles associated to it or other associated characteristics. Recommendations like have a high enough score threshold and/or which get user input may be executed by the user similar to FIG. 6 steps 614-618.

In the embodiment, similar to that in FIG. 7, based on the received signal data by the first central device, the first central device optionally along with the assistance of a remote server like audience engine 508 can recommend (compute relevancy/interest scores) to the user(s) of the personal device(s) or other central devices in light of the first central device's profile/characteristic for those devices that sent beacon signals to the first central device.

Like in FIG. 7, step 708, 720 and 722, multiple profiles may be considered. The first central device and/or audience engine may first determine if the detected device signals are associated to profiles that are relevant to each other. If so, then the first central device and/or audience can create a composite profile like in step 722 etc. The composite profile may be between profiles associated to the personal devices the first central device detects and may even include profiles of the first central device and/or other central devices the first central device detects. Alternately, as described in the embodiments below, a composite profile/affinity prediction tool and/or using scaled similarity measure that is substantially comparable between users and their profiles and/or central devices and their profiles (described below) can be used to address multiple profiles belonging to devices detected by the first central device.

Like in step 724, ranking of content/actions that are available to the detected devices and/or the first central device according to the above paragraph's consideration of multiple profiles may be done. Then reranking like in step 718 occur and the reranked list may be generated considering the properties of the first central device.

Steps similar to that of 726 and 710-714 may occur. Recommendations such as those with a high enough relevancy score (beyond a threshold) may be broadcast to the personal devices and displayed to the user(s) from the first central device for execution and/or voting. Recommendations may be displayed directly on the central device screen as well and executing on the first central device, other central device or even on one of the personal devices that sent a beacon signal to the first central device or a combination of these devices.

### Embodiments of Computing a Composite Profile/Ranking

The above, discussed composite profiles users and rankings which are used to consider the profiles and associated data of multiple users can be computed with a variety of tools. The various tools may focus on aggregating or otherwise considering interests and optionally their statistical probabilities across users in order to have a substantially relevant (substantially high statistical interest/likelihood of representation probability) recommendation for the group of users as a whole.

In one embodiment, end user profiles themselves can be aggregated as illustrated above e.g., across different cooking show interests and corresponding statistical propensities for interest.

In another embodiment that does not have to rely on aggregating profiles in order to give a group recommendation—which may avoid unexpected unscaled properties/characteristics that may occur in averaging individual user profiles/interest graphs such as in the previous cooking shows example, a composite profile/affinity prediction tool can be created without directly relying on the interests/characteristics of each of the end users. Tools that accomplish this are: 1) aggregating ranks across users, and 2) aggregating a scaled similarity measure.

In discussing the tools above, several examples will be discussed. First, in this embodiment, a profile may be comprised as a set of known interests/characteristics tags of a given user associated to a statistical propensity which may be positive or negative (e.g., a statistical probability) for each. These may be determined by user input/activity as discussed in the above referenced patent applications. “Content spectrum” is comprised of the set of interests/characteristics/actions (e.g., tags and optional associated statistical probabilities) linked to a given content (e.g., TV Show) which could be a brand/ad/user or other data the user may be interested in (such as data associated to the user e.g., a movie on her Netflix account). “Rank” in this embodiment may be the relative position of one piece of content compared to other pieces of content e.g., cooking show X is ranked higher than cooking show Y.

In order to match a user profile to a content spectrum, a measure is computed between the user profile and the content spectrum. This measure gives a score which determines how high the content spectrum is in given the user profile. In this embodiment, for each user and piece of content a score/propensity is computed (e.g., a relevancy score). This measure may be scaled but if not scaled it is user-dependent which means it may or may not be substantially accurate to compare between users.

From here, there are two embodiments (the second embodiment is discussed in the paragraph below). The first embodiment being to use ranks instead of ratings of the similarity measure to enable the group recommendation. Thus each profile of a group is comprised by a ranked list of content. Here a tool can be used to combine the plurality of ordered lists from the users to get an aggregated rank list which substantially balances the individual user ranks. There are at least two tools that may be used to do this balancing (rank aggregation) to combine several ordered lists in a proper and efficient manner to get an aggregate rank which is substantially well-balanced in light of the individual ranks: first is to use a majoritarian principle to accommodate the majority of individual propensities/preferences in which the resulting group ranking is typically based on the number of pairwise wins between items within individual user rankings. A second tool is to seek a consensus among individual user rankings. Here, the resulting group ranking is typically a form of ranking averaging.

A second embodiment is changing the score measure/propensity inorder to end with a scaled similarity measure that is substantially comparable between users as opposed to focusing on the user rankings as discussed in the paragraph above. If this is done, then the aggregation could be done directly with the propensity vector resulting from the similarity measure and computed on all pieces of content for all the users. Then, an average per piece of content could be used to determine a group recommendation.

With this second embodiment above, the focus is on determining a new similarity measure which enables the comparison between pieces of content for a given user profile and between various user profiles for a given piece of content. This may be accomplished by using a Jaccard criterion and an extend Dice criterion (in their continuous versions). In addition, its standard version called Sørensen-Dice index can be used.

### Embodiments of Ranking Factors

The resulting rankings from the tools disclosed herein can then be treated as a partial result. Specifically, rankings may be adjusted (re-ranked) to take into account other features such as the popularity of the content, the time/date, user context, user proximal context, language, holidays, demographics, user moods etc., Context-range (Tx), who else in room, time of day, content/actions or other data available, past history of the user profiles and/or devices, date, weather and other factors as desired which may be used to compute a final ranking.

### DNS Embodiment

In one embodiment, DNS (Domain Name System) is used to help facilitate communications between devices 502, 506, 512 and 508 and other devices as desired. DNS may allow various devices which may be previously not have been configured to communicate to communicate with one another.

A DNS system allows a server like audience engine server 508 to facilitate communication between devices 506, 512 and 502 with a minimum of preconfiguration. Specifically, in one embodiment, if devices 506, 512 and 502 have been pre-configured to communicate with audience engine 508, audience engine 508 would then use DNS to facilitate communications between device 506, 512 and 502. In one embodiment, each of these devices would be assigned a URL (or any identifier like a UUID) by audience engine 508. Here, audience engine 508 functions similar to that of an ISP/DHCP server. Behind each URL, various subdomains may be assigned (root domains, subdomains and resource names can be used in a hierarchy). Audience engine 508 would not have to permanently assign DNS addresses to each device.

In one embodiment, like that illustrated in FIG. 5 and FIG. 7 (using iBeacon or substantially similar signals that may use direct non-networked communication), DNS can be used to facilitate communication between the devices. For instance, as device 512 detects a UUID of device 502 and a UUID in device 506 from the custom data signals (like the customized Bluetooth signal illustrated in FIG. 4) they broadcast, device 512 can send this information to an audience engine 508. Device 506 may also transmit the UUID from device 502 and device 512 and communicate this to audience engine 508.

Given audience engine 508 detects that both device 512 and 506 detects one another (via their iBeacon signals) in addition to the UUID of central device 502, it may be assumed that these three devices are in proximity (the Tx Power transmitted by these devices in the custom signal may also be examined) by each other e.g., the audience engine can make this assumption given the devices are configured to communicate with the audience engine. As such, URLs or other designations may be assigned to each of the devices to help them facilitate communication directly with each other or through the audience engine or other device.

In one example, the URL or other identifier assigned may reflect the location or even the central device that is detected. In one example, the domain name “samsung60inchTV.x” may be assigned to the central device. Adding associated devices (devices that are in proximity of a given device) can be done using the domain name. For instance, device 506 may then be assigned the name “samsung60inchTV.briansiPhone” and device 512 may be assigned the name “samsung60inchTV.maxesiPhone”. In another embodiment, the domain name “fremont.livingroom” may be assigned to device 502. Device 506 and 512 may then be assigned the names “fremont.livingroom.user1” and “fremont.livingroom.user2” respectively. As above, any designations can be used.

Communication of the above can be done by the devices communicating through the audience engine and/or the devices communicating directly with each other. The devices might get the above identifiers mapped to their IP addresses by the audience engine.

Device 506, 512 and 502 may be preconfigured by a downloaded application from iTunes or other source to communicate with audience engine 508 and get a DNS address or other identifier from the audience engine 508—optionally upon certain triggers. Triggers may include the detection of data within a customized Bluetooth data signal like that illustrated in FIG. 4, entry into a certain geophysical space registered with the audience engine 508, execution of a certain command, detection of a central device such as IPTV 502 or other event.

In other embodiments, the DNS functions may be done by one of the user devices or even a central device or a combination of these and the audience engine 508.

### Toolset #3 Enhanced Consumer Device Notification System

A long-standing problem merchants face is determining what specifically about a particular good/service is of interest to a consumer. Interest varies substantially depending on the individual consumer. Specifically, out of a plurality of characteristics, what specific characteristic(s) about the good/service is a specific consumer focused on as opposed to what different characteristic a second consumer may focus on.

For instance, if a product was a pink iPhone case with a sparkly diamond pattern, different consumers may react differently to these properties. A first consumer may only react positively to the pink characteristic while another my only react to the diamond pattern or may even react negatively or neutrally to the pattern. Thus, what is needed is substantial granularity in determining what properties of a good/service/ad/coupon/tv show/content etc., trigger a positive/negative or neutral reaction specific to a particular consumer and her profile. This is so that the relevant offering may be displayed to the user and optionally, the trigging characteristic accentuated to the consumer upon display. This trigger may be called an offering characteristic(s) notification trigger or keyword(s) notification trigger. Triggers may be any data such as combinations of the aforementioned that describe or is associated to an offering.

These customized notifications become even more important to merchants when the above is paired with beacons associated to offers at merchant locations substantially near the offer/good/services the beacon is associated to or at other geographic locations. Specifically, a highly granular consumer notification system could trigger only the highly relevant notifications when the consumer's device is geographically substantially near the beacon associated with the offer. Alternately, the user might be notified when in proximity to a beacon but get a notification regarding a related beacon that may not be within beacon signal range (if this beacon is more relevant). This is helpful because a merchant may have hundreds of thousands of goods in a store associated to a large number of beacons, but to prevent annoying the consumer—only alert/notify the consumer to those that are the more relevant based on her specific profile and the specific types of goods she will react positively to when she is substantially near the beacon/offering. (Typically the beacon is physically placed substantially near the offering/good/service such as the product package or display stand etc.)

In the same vein, if merchants knew what specific properties and characteristics triggered affinities (e.g., keywords) for specific user profiles, Merchants could focus their efforts (marketing budgets etc.) into just those specific properties e.g., keywords like “pink” for a particular user that trigger user purchase or other actions. Specifically, this may require measuring the value (e.g., relevancy, interest or monetary value) of a keyword to a specific consumer profile or type of consumer. As such, in the spirit of competition between merchants, if a particular keyword is demonstrated to be valuable/relevant in light of a particular consumer or group of consumers, a merchant could increase the bid they would pay for a particular keyword/characteristic notification trigger of a merchant's own product/offering (such as that triggered by a beacon as discussed above) a specific consumer receives or even a trigger activated by a consumer coming into signal range of a competitor's beacon associated to a substantially related good that first merchant offers. In the later case, said notification being triggered by a consumer detecting a beacon signal from a competitor's beacon which is associated to a substantially similar product/offering at the competitor's store or elsewhere. For clarity, this may occur even when the consumer detects their competitor's beacon while at the competitor's store and the consumer is not within beacon signal range of the substantially related beacon/product.

### Configuration

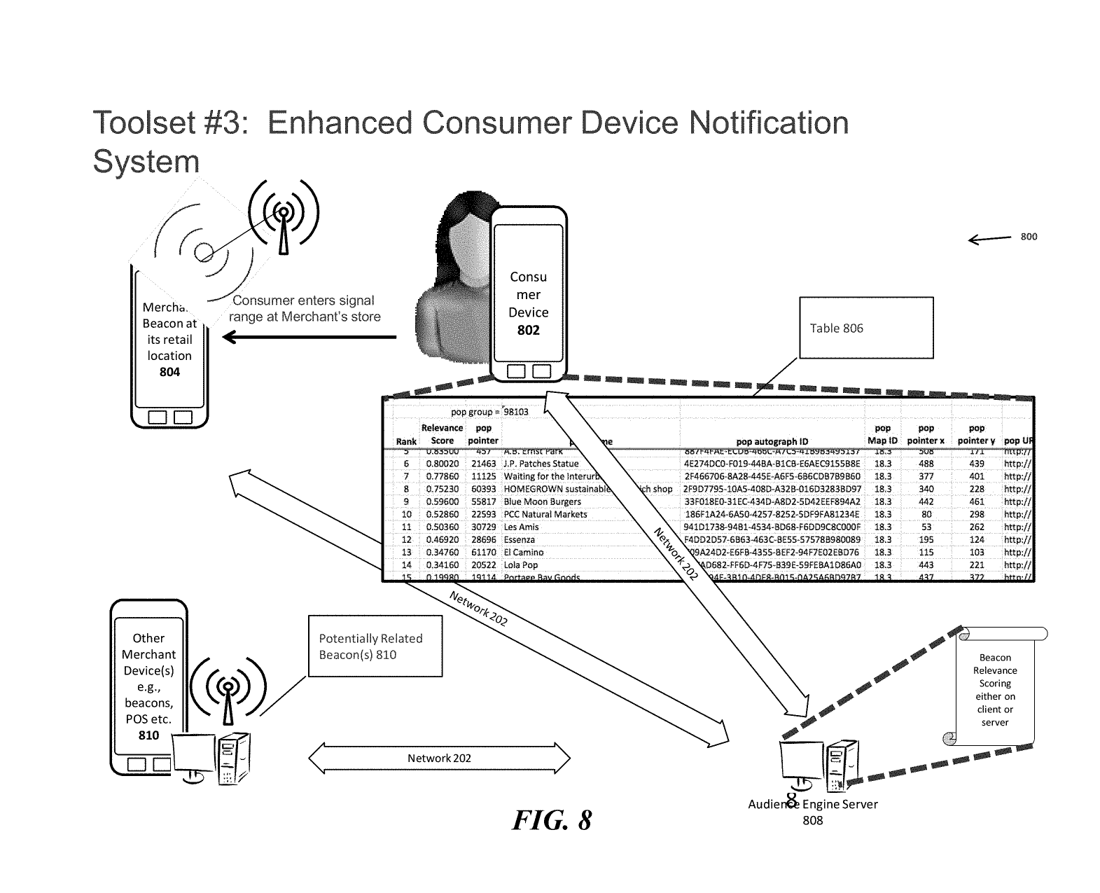

As discussed in the above text and also in the above referenced patent applications, a beacon and its signal can be associated to a good/service/merchant or other entity, object or data (as seen in Table 806 in FIG. 8). The relationship can be relating a product, offering, ad, coupon, keyword, picture, sound, movie, brand, text, geographic location, properties, characteristics, pointer, or other data (herein “beacon content”) to a beacon's signal information. This may be done by recording the relationship in a database or spreadsheet via a computing device. An example would be to register/associate a beacon physically placed substantially near, on or in a retail store display having the pink, sparkly iPhone cases under the ownership of Merchant X, having a price point Y, location Z, brand name A, properties B, C, D, associating to Tags 1, 2 and 3, demographics 4, 5, 6 and other data related to the beacon such as related statistical probabilities. (herein the “beacon content”).

A previously created user profile created by brand sorting or other method may be used to optionally help score the beacon content with a relevancy score in light of a specific user profile or type of user profile as discussed below.

The relevancy scoring may also involve determining the user's current mode of movement/transportation e.g., walking, car, bus, subway etc., to make recommendations of proximally located beacons and their offerings make more sense. Mode(s) of transportation can be determined by asking the consumer directly, or deducing it from the device's speed or direction of movement etc.

In addition, a merchant can at anytime, bid on some or a portion of the beacon's content. E.g., a merchant may bid $1.00 on the keyword “pink” and $10 on the keyword “sparkly”. This bid may be stored on an audience engine server 808 or other device. Merchants might be able to see what their competitor's bids are on the content they are bidding on as well.

### Initial Notification Trigger of a Detected Beacon

Also as previously discussed in the above patent applications and illustrated in FIG. 8, the consumer's device may detect a merchant beacon 804 in system 800. The device may be configured to do such by downloading an application from the iTunes store or Google Play Store. Said application may be preconfigured to detect particular beacon signals and associated the detected signals to specific beacon content.

Once the beacon signal is detected by the consumer's device 804, the device (or a remote device such as audience engine 808) may access the association of the signal to beacon content, other beacons in the same or substantially near geographic area (in light of the user's mode of transportation) or any other content related beacons or other data based on data the merchant(s) has made available such as all beacons associated to a particular ZIP code with the same ZIP code as the detected beacon etc.

### Determine Related Beacons/Relevancy Score for Beacons Related to a Detected and Relevancy Beacon

Once a user's device detects a beacon(s) and determines its associated content, the beacon and its content may be scored in light of the user's specific profile such as its characteristics and the characteristic statistical probabilities. This is discussed in the above referenced patent applications.

Scoring the detected beacon may consider various variables such as 1) components(s) of the user's profile such as browsing history, propensities/statistical probabilities of characteristics (e.g., statistical probability of being female etc.), past locations traveled to, name, address, associations, past purchases, browsing history, contact information, text message/emails etc., 2) the geographic distance between the beacon and the current location of the user's device, 3) the monetary bid value the merchant (or other merchants e.g., a competing merchant) assigns on the beacon and its associated content, 4) the user's current mode of transportation and many other variables such as time of day, date, holiday, sale items etc. The weights of these variables relative to one another may be varied as desired. For instance, the weights might be varied by: the distance between the beacon and the user's device may be more heavily weighted than bid value the merchant assigned to the beacon and associated content. Beacons with a certain threshold score may be determined as “relevant beacons”.

Once the detected beacon is determined to be relevant to the user's profile (e.g., relevance score exceeds a threshold), beacons potentially related/relevant or (otherwise associated) to the newly determined relevant beacon's profile can be determined. Any beacons and their content can be examined for relevancy. For instance, among the beacons to be examined may be: a merchant might have a beacon catalog of their own beacons and even beacons/content of their competitors, beacons located within the same ZIP code or other geographic area, beacons belonging to the same merchant or even those beacons of different/competing merchants etc. In another embodiment, even if the detected beacon's profile is determined not to be relevant to a user (e.g., given a relevancy score below a threshold), beacons related/relevant to the detected beacon can be examined (as discussed below) and be given a relevancy score and potentially trigger a user notification.

This determination of which of these other non beacons (e.g., beacons that are not currently detected by the user's device) are related to the currently detected beacon can be done by examining the newly determined relevant detected beacon's content and applying a taxonomy, marketing data and other tools such as social media data, contextual data (holidays, relationships, time/place, previous purchases) to determine substantial similarities/relevancies and/or desired geographic distances between the detected beacon to the potentially related beacon's content. Any desired criteria can be used to determine relevancy such as substantially similar beacon characteristics and/or associated probabilities, substantially similar price points, product categories etc.

In one embodiment, two beacons (e.g., beacons 804 and 810) can be determined as relevant/related to each other if they have a common characteristic (e.g., characteristic tag) in common or a substantially similar tag and/or statistical probability, share substantially common marketing data or data that is substantially the same as determined by a taxonomy.

In one embodiment, relevancy can be determined at least in part, by examining if the beacons are in a substantially nearby geographic area and/or if the beacon is associated to substantially similar content in light of the detected beacon's content or not etc. (Related beacons might not even belong/be owned/associated by the same merchant or brand).

Once two beacons are determined to be relevant/related to each other, the related beacon also can be given a relevancy score in light of the user profile for eventual relevancy scoring comparison between beacons as discussed below.

In one example of determining if a newly detected and relevant beacon has any beacons that are relevant/related (such as beacon 810) to it—substantial commonality in content such as a keyword, or characteristics, associated statistical probabilities, tags etc. can be determined and used to determine relevancy from the above mentioned beacon catalogs. For instance, a common or substantially similar keyword(s) (or category or characteristic) associated to the detected beacon and another beacon's content placed at a competitor's store may determine that the two beacons are related because their content shares a keyword e.g., keyword “pink” or “pink iPhone case” have substantially similar or the same characteristics and optionally similar associated characteristic statistical probabilities or the beacon offerings belong to the substantially same demographic etc. These may be assigned and determined to be related/relevancy by marketing data and/or taxonomy. In another embodiment, the substantially common data discussed above can be determined to exist or not between beacon 810 and the user's profile.

Determining if beacons are related might also be established via relevancy scores e.g., by scoring the second beacon 810 in light of the user profile in a manner similar to that of relevancy scoring between the user profile and the first detected beacon 804. A relevancy score might be assigned to beacon 810 using the same or similar tools. If the scores between beacons are substantially similar overall or over certain beacon content and/or within a certain relevancy score threshold e.g., +/−5% or +/−10%, then the two beacons may be related.

Relevancy between beacons might also be established by relevancy scoring the potentially related beacon's (beacon 810) content/profile in light of the newly determined beacon's profile/content (beacon 804). This maybe similar to scoring a beacon in light of a user profile. For instance, the potentially relevant beacon/content of beacon 810 is given a relevancy score in light of the content of the newly determined relevancy beacon's content 804. If a score is over a threshold, then the beacon can be designated as related. Optionally if beacon 810 is determined to be relevant/related to beacon 804, beacon 810's content/profile can receive a relevancy score in light of the use profile and beacon 810 and 804 scores are compared and optionally the higher of the two if it exceeds a threshold can be the subject of a user notification.

Once beacon 810 is determined as related to the newly determined relevancy beacon 804, this second related beacon (e.g., a beacon at the competitor's store) may then be assigned a relevancy score in a manner similar to the first detected beacon discussed above wherein the score is in light of the user's profile and optionally other factors. Relevancy scoring between the user profile and this second related beacon may be by similar or identical tools used to determine the relevancy score between the first detected beacon and the user so the beacon scores can be compared below. A common or substantially similar category of beacon offering, price point, geographic location distances from the user, affiliation (e.g., within the same shopping mall) or other variable can be used as well to help determine beacon relevancy scores and that of their content.

Here, since, the competitor's related beacon 810 is likely a farther geographic distance (e.g., out of beacon signal detection range if the user 802's device) from the detected beacon 804 and the user 802, the location and user mode of transportation will be of specific interest in relevancy scoring (e.g., the distance weighting) of the competitors' beacon. In addition, a competitor may have bid more money (increases the relevancy score) to have their related beacon get the right to notify a given consumer than another merchant, which may affect relevancy scoring. The bid may be placed on a consumer with specific profile attributes like certain profiles with certain keywords, or profile of a having certain characteristics like smart phones, in a certain demographic or other characteristic that a beacon offering and a profile may be matched by etc. These additional variables may be used in any combination in the relevancy score of both beacon 804 and 810 in which they may be used in the score of one of the beacons and not in another beacon and/or weighted differently.

Like in the above scoring between the user and the detected beacon 804, various factors can affect relevancy scoring of the second related beacon 810 and the user: 1) the geographic distance between the second related beacon and the current location of the user's device, 2) the monetary bid value the merchant (or other merchants e.g., a competing merchant) assigns on the second related beacon and its associated content, 3) the user's current mode of transportation and many other variables such as time of day, date, holiday, sale items etc. The weights of these variables relative to one another may be varied as desired. For instance, the weights might be varied by: the distance between the beacon and the user's device may be more heavily weighted than bid value the merchant assigned to the beacon and associated content.

The relevancy scores of these two beacons (the detected beacon and second related beacon) may be computed and compared.

These computations may be done locally or remotely and downloaded to the client as in table 806.

### Compare Scores for Each Beacon & Threshold

Once determined, the relevancy scores of the beacons such as the detected beacon 804 and a remote beacon 810 (which may not be currently be detected by user device 802) may be compared. The beacon with the highest relevancy score in light of the user profile (that exceeds a desired threshold) may trigger a notification to alert the user 802 of the beacon and its content e.g., a pink sparkly iPhone case. For clarity, it is noted that the alert may not be for the beacon that is detected by device 802, but a remote related beacon that may or may not be substantially geographically near the user 802 at the time of notification such as beacon 810. In other words, the beacon whose content is displayed to the user may never have been detected by the user device 802 at all or may be out of beacon signal range at the time of detection of the first merchant's beacon. This notification (of either beacon 804 or 810) may occur just after or substantially after the user 802 detects beacon 804). If the user later detects either beacon, the detection may trigger a notification of beacon with the highest relevancy score.

Optionally, a threshold relevancy score value may block any user notification unless the highest beacon relevancy score exceeds the threshold relevancy score value. Alternately, a plurality of beacons that exceed a given threshold e.g., the top three beacons (or any desired number) with the highest relevancy scores may be presented to the user for user input-optionally substantially after the user 802 detects of one of these beacons or a related beacon.

### User Notification

The notification may be a conventional notification as displayed/heard in iOS/Android. In which text, sound and/or a graphic, camera flash, notification light may be displayed/activated. In one embodiment, using Apple's ios operating system, the alert occurs without the consumer having to open a specific application (ibeacon notifications and similar technology may trigger notification without a specific application being open or even active at time of notification/iBeacon detection).

### Get User Input & Optionally Integrate Data Input in User Profile

Once the notification is displayed to the end user, the user may read the notification, provide input on or near the notification on the touch screen or Swote™ up or down on it etc. With any of this input, the user's profile may be altered to reflect a potential interest, lack off interest or neutral interest/affinity in the subject of the notification such as a change in the statistical probability that a characteristic(s) associated with the beacon is true or false as discussed in the above reference patent applications or even add a characteristic and associated probability that did not previously exist in the user profile e.g. those belonging to a beacon(s) that she expressed interest in.

If no input is entered by the consumer, then other related or non related beacon content may be displayed to the user and his/her profile may be adjusted to reflect a potential negative or neutral affinity for the subject of the notification. This other content that may be displayed may be scored in a manner similar to the above e.g., the second highest scored beacon may be displayed to the user via notification or other tools.

### Input Analysis (e.g., Determine Keyword Value)

From the consumer input or lack of input to the notification, the associated content, and the merchant bids(s) on the content and the other variables introduced above, various deductions/determinations can be made. Specifically, a monetary value of a piece of beacon content such as a beacon keyword value or value of a specific piece of content such as the demographic type of a profile belonging to senior citizens can be determined and demonstrated to a merchant and their competitors via the steps above. In other words, values of the similar content between beacons can be ascertained such as the monetary value of a keyword. The content can be auctioned off to the merchant associated to the content that places the highest monetary bid or second highest monetary bid.

In addition, merchants can be informed of the value of keywords or other portions of beacon content as demonstrated by other merchant's bids on a beacon keyword. The merchants may then be invited to bid on keywords and/or outbid the bids of other merchants. Various methods of auctioning or reverse auctioning of keywords and substantially related keywords are contemplated. This increase in bidding will give extra weight to their chosen beacon content during relevancy scoring so they have a better chance of notifying the consumer as opposed to their competitor and her beacon content.

Competition Enhancement Provides Consumer with Better Deals and Other Benefits

Via the steps above, the consumer may greatly benefit by the increased awareness that the merchants get. Specifically, merchants may be more aggressive in luring away consumers who are geographically further from their competitor's beacon goods/services by bidding more. The merchant offing the higher bid may in turn offer a better deal to the consumer on the same or related good related to the beacon determined as being relevant to the detected relevant beacon.

As such, a by-product is that merchants are financially motivated to out-bid one another for the profile or profiles of a certain kind or all users. In other words, an end user whose device detects a beacon at a first merchant may not be shown that beacon's content. Rather, a beacon content at a competing merchant with substantially similar beacon content may be shown because the competing merchant bid higher for that consumer to be notified using the tools above or vice versa depending on the bid value and its effect on the relevancy scoring of a particular beacon.

### APPENDIX A

As discussed in some of the above reference patent applications-Beacon Examples in one Embodiment:

UUID/GUID

A UUID may be the equivalent to a iBeacon's proximity UUID (128-bit UUID or 16 byte string).

Here, a UUID is a code or other identifier that represents a substantially large group of associated beacons (e.g., related by having identical or substantially similar tags). The UUID transmitted may be identical for all these associated beacons. This may be the largest grouping of beacons compared to the major and minor groupings. In one embodiment, a single UUID value may represent all beacons associated to a nation such as the United States.

### Major Embodiments

A major is a code or identifier that may be equivalent to iBeacon's Major (32-bit integer or 2 byte string). Major values may point to specific subset of the UUID beacons.

The beacon major represent a smaller group of beacons made from a UUID grouping of beacons with the same UUID. In a similar manner, they may also share substantially the same tags such as well as the same major and UUID tags. The major beacons may be a larger grouping than beacon(s) associated by a minor. In one embodiment, a major is chosen in which the number of beacons associated with the major is 15 beacons or greater. This substantially improves the privacy of the user when she requests a matrix computed based upon a major or other data.

### Minor Embodiments

A minor is a code or identifier that may be equivalent to iBeacon's Minor that is a (32-bit integer or 2 byte string). Minor values point at an individual fixed or mobile beacon.

Beacon minors may identify individual beacons that belong to the same UUID and same major. Beacon minors may also belong to multiple UUIDs and majors. In one embodiment, the beacon minor value transmitted is unique to the beacons in the UUID.

Various other embodiments of the above are contemplated as well.

1. A processor-based system, comprising:
a transceiver;
memory for storing instructions that are executable by processor electronics;
processor electronics configured to execute the instructions in order to:
i. using the transceiver, detect a data signal transmission from a vendor/merchant server in a non-networked manner;
ii. determine if data associated with the signal transmission is relevant to an end user;
iii. if data is relevant to an end user, then request an identifying code from an audience engine server;
iv. receive the identifying code; and
v. broadcast the identifying code to the vendor/merchant server in a non-networked manner.
